(19) United States
(12) Patent Application Publication
(10) Pub. No.: US 2022/0127421 A1
(43) Pub. Date: Apr. 28, 2022

(54) POLYURETHANE COPOLYMERS AND BLENDS, METHODS OF MANUFACTURE THEREOF AND ARTICLES CONTAINING THE SAME

(71) Applicant: UNIVERSITY OF FLORIDA RESEARCH FOUNDATION, INC., GAINESVILLE, FL (US)

(72) Inventors: Anthony B. Brennan, Gainesville, FL (US); Vishal Vignesh, Gainesville, FL (US)

(21) Appl. No.: 17/434,512

(22) PCT Filed: Mar. 5, 2020
(86) PCT No.: PCT/US2020/021243

§ 371 Date: Aug. 27, 2021

Related U.S. Application Data
(60) Provisional application No. 62/814,154, filed on Mar. 5, 2019.

(51) Int. Cl. C08G 71/04; C08F 220/56; C08F 222/10; C08F 220/22

(52) U.S. Cl. CPC C08G 71/04; C08F 220/56; C09D 175/04; C08F 220/22; C08G 2210/00; C08F 222/1065

(57) ABSTRACT

Disclosed herein is a composition comprising a water soluble monomer or polymer; a fluorine functionalized acrylate; and a non-isocyanate urethane acrylate. Disclosed herein is a method comprising mixing a water soluble monomer or polymer, a fluorine functionalized acrylate and a non-isocyanate urethane acrylate to form a composition; and curing the composition.

### CROSS REFERENCE TO RELATED APPLICATIONS

This application claims the benefit of U.S. Application No. 62/814,154 filed on Mar. 5, 2019 which is incorporated herein by reference in its entirety.

### STATEMENT REGARDING FEDERALLY SPONSORED RESEARCH & DEVELOPMENT

This invention was made with government support under Contract Number N00014-16-1-3120 awarded by the Office of Naval Research. The government has certain rights in the invention.

### BACKGROUND

This disclosure relates to polyurethane copolymers and blends, methods of manufacture thereof and articles containing the same.

Biofouling is the undesirable accumulation of biological organisms onto surfaces. Marine biofouling is a complex, dynamic phenomenon having profound economic and environmental consequences that affects the maritime industry severely. Recently a class of hydrogels has been introduced to combat biofouling. Hydrogels provide unique slip boundaries to low adhesion but are typically mechanically weak having a modulus of 1 kPa to 1 MPa.

It is therefore desirable to manufacture hydrogels that are tougher and that can be used in coatings that minimize biofouling.

### SUMMARY

Disclosed herein is a composition comprising a water soluble monomer or polymer; a fluorine functionalized acrylate; and a non-isocyanate urethane acrylate.

Disclosed herein is a method comprising mixing a water soluble monomer or polymer, a fluorine functionalized acrylate and a non-isocyanate urethane acrylate to form a composition; and curing the composition.

Disclosed herein is a polyurethane copolymer comprising a water soluble polymer; where the water soluble polymer is covalently or ionically bonded to a non-isocyanate containing polyurethane, where the non-isocyanate containing polyurethane is derived via polymerization of a composition comprising a water soluble monomer or polymer; a fluorine functionalized acrylate; and a non-isocyanate urethane acrylate.

Disclosed herein is a method of manufacturing a polyurethane copolymer comprising reacting a non-isocyanate containing polyurethane with a water soluble polymer to produce the polyurethane copolymer, where the water soluble polymer is covalently or ionically bonded to the non-isocyanate containing polyurethane and where the non-isocyanate containing polyurethane is derived via polymerization of a composition comprising a water soluble monomer or polymer; a fluorine functionalized acrylate; and a non-isocyanate urethane acrylate.

### BRIEF DESCRIPTION OF THE FIGURES

FIG. 1 depicts the reaction between carbon dioxide and an oxirane ring to form cyclic carbonates;

FIG. 2 shows the reaction of a cyclic carbonate with a diamine to form a urethane;

FIG. 3 shows the endcapping of the various non-isocyanate urethanes (from the FIG. 2) with 4-methylene-1,3-dioxolane;

FIG. 4 shows the functionalization of the various non-isocyanate urethane methacrylates with 4-methylene-1,3-dioxolane;

FIG. 5 shows the functionalization of the various non-isocyanate urethanes from the FIG. 2 with a methacrylate;

FIG. 6 shows the functionalization of the a non-isocyanate urethane dioxolane from the FIG. 3 with phosphoric acid;

FIGS. 6(A) and 6 (B) show the functionalization of the a fluorinated non-isocyanate urethane dioxolane from the FIG. 3 with phosphoric acid;

FIG. 7 shows the functionalization of the a non-isocyanate urethane dioxolane from the FIG. 3 with sulfonic acid or an anhydride;

FIGS. 7(A) and 7 (B) show the functionalization of a fluorinated non-isocyanate urethane dioxolane with sulfonic acid;

FIGS. 7(C) and (D) show the functionalization of a fluorinated non-isocyanate urethane dioxolane with any anhydride;

FIG. 8 shows the reaction of a cyclic carbonate with a cyclic diamine to form a urethane;

FIG. 9 shows the reaction of the urethane with a methacrylate to form a non-isocyanate urethane dimethacrylate;

FIG. 10 shows one exemplary embodiment of how a non-isocyanate urethane dimethacrylate can be used to form a hydrogel;

FIG. 11 shows on exemplary embodiment of the reaction of the non-isocyanate urethane dimethacrylate with a fluorine containing molecule to produce a fluorinated non-isocyanate urethane dimethacrylate;

FIGS. 12-19(A) show various exemplary structures of non-isocyanate urethanes functionalized with fluorine containing molecules, sulfur containing molecules, phosphorus containing molecules and anhydride functionalized molecules.

### DETAILED DESCRIPTION

Disclosed herein are toughened polyurethane hydrogels that may be used in applications for mitigating biofouling. The polyurethane hydrogels are manufactured from a composition comprising a water soluble monomer, a fluorine functionalized acrylate and a novel non-isocyanate urethane based acrylate that functions as a crosslinker. In an embodiment, the water soluble monomer is an acrylamide. Other water soluble monomers and polymers that may be used in lieu of the acrylamide are listed below. In a preferred embodiment, the composition comprises an acrylamide, a fluorine functionalized acrylate (e.g., hexafluorobutylmethacrylate) and a novel non-isocyanate urethane based acrylate that functions as the crosslinker.

An example of the non-isocyanate urethane based acrylate is a novel non-isocyanate urethane based dimethacrylate (NIUDMA). The non-isocyanate urethane dimethacrylate functions as the cross-linker.

Hydrogels are polymer networks that may contain up to 90% water by volume. Hydrogels have typically been found to have weak mechanical properties particularly toughness and modulus (about 100 to 1000 times lesser than solids). Swollen hydrogels are damaged easily by external mechanical forces. Some hydrogels have been developed having toughness and modulus values comparable to rubbers and cartilage for biomedical applications. However, none have been developed for antifouling applications.

The composition for producing the polyurethane hydrogel comprises an acrylamide, a fluorine functionalized (meth)acrylate and a non-isocyanate urethane based acrylate that functions as the crosslinker. The polyurethane hydrogel is the reaction product of the composition comprising the acrylamide, the fluorine functionalized (meth)acrylate and the non-isocyanate urethane based acrylate. The polyurethane hydrogel is therefore a copolymer of polyacrylamide, a fluorinated poly(meth)acrylate and the non-isocyanate urethane acrylate. It is crosslinked to form a hydrogel that is tough and can be used advantageously in medical applications.

Depending upon the form of the reactants (i.e., monomeric or polymeric form) the resulting copolymer may be a random copolymer or a block copolymer. In an embodiment, each of the reactants is in monomeric form prior the reaction and this results in a random polyurethane copolymer. In another embodiment, one or more of the reactants is in polymeric form prior to the reaction and this produces a polyurethane block copolymer.

The water soluble monomer may be in monomeric form or in polymeric form prior to crosslinking. In an embodiment, the water soluble monomer is an acrylamide. Other water soluble monomers and polymers that may be used in lieu of or in combination with the acrylamides are listed below. The acrylamide may be in monomeric form or in polymeric form in the composition prior to crosslinking. The acrylamide is present in the composition in an amount of 10 to 80 mole percent, 20 to 70 mole percent, 30 to 60 mole percent based on the total weight of the composition. The polymeric form may have two or more monomers that are covalently bonded together prior to being added to the composition. In a preferred embodiment, the acrylamide is in monomeric form.

The fluorine functionalized acrylate has the structure represented by the formula (Ta):

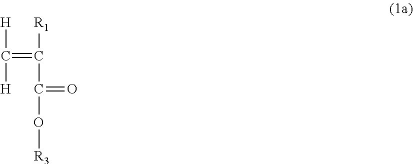

where R₁ is a hydrogen or an alkyl group having to 10 carbon atoms and is a C₂₋₁₀ fluoroalkyl group or a group having the structure of formula (2a):

—R₄—(CF₂)n-CF₃ (2a),

where R₄ in the formula (2a) is an alkyl group having 1 to 10 carbon atoms and n has a value of 1 to 10, 2 to 8 or 3 to 7.

Examples of compounds having the structure of formula (1) are trifluoroethyl (meth)acrylate, dodecafluoroheptyl(meth)acrylate, 2,2,3,4,4,4-hexafluorobutyl (meth)acrylate, 2,2,3,3,4,4,4-heptafluorobutyl (meth)acrylate, 2,2,3,3,4,4,5,5,6,6,7,7-dodecafluoroheptyl (meth)acrylate, 2,2,3,3,4,4,5,5-octafluoropentyl (meth)acrylate, 2,2,3,3,3-pentafluoropropyl (meth)acrylate, or the like, or a combination thereof. In a preferred embodiment, the fluorine functionalized acrylate is a 2,2,3,4,4,4-hexafluorobutyl (meth)acrylate.

The fluorine functionalized acrylate may be in monomeric form or in polymeric form in the composition. The fluorine functionalized acrylate is present in the composition in an amount of 10 to 80 mole percent, 20 to 70 mole percent, and 30 to 60 mole percent based on the total weight of the composition. The polymeric form may have two or more monomers that are covalently bonded together prior to being added to the composition.

The crosslinker is a non-isocyanate urethane acrylate. In an embodiment, the crosslinker may be a non-isocyanate fluorinated polyurethane methacrylate (hereinafter fluorinated polyurethane methacrylate). In yet another exemplary embodiment, the fluorinated polyurethane methacrylate can be functionalized with molecules that contain phosphorus atoms, silicon atoms, or other reactive functionalities that render important properties to the resulting molecule. These properties can involve flame retardancy, moisture uptake, abrasion resistance and the like.

In conventional polyurethane (PU) preparation processes, the polyurethane is synthesized by using isocyanates (such as diisocyanates and polyisocyanates) and polyols (such as diols or polyhydroxy polyols with high functionality) as major raw materials, but the manufacturing process of this sort usually requires phosgene which is a severely toxic pollutant. If the phosgene is leaked accidentally during the manufacturing process, the phosgene will pose an immediate threat to our environment and jeopardize our health such as causing pulmonary edema, and the manufacturing process itself will lead to a certain degree of risk. Therefore, scientists attempt to use non-isocyanates routes (which use absolutely no isocyanates at all) to manufacture polyurethane.

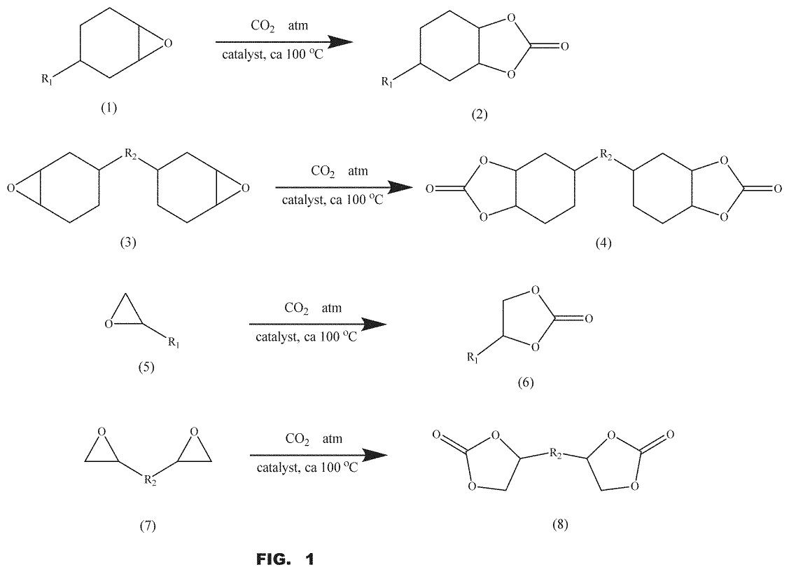

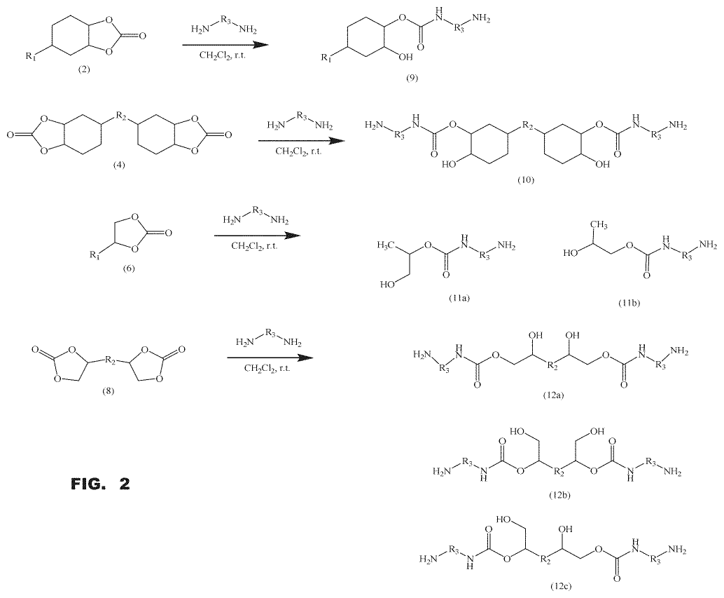

Polyurethanes can be manufactured by a method that involves not using any diisocyanates, wherein five-membered cyclic carbonates (Bis(cyclic carbonate)s) and primary amines are reacted at room temperature to produce a high yield of 3-position hydroxyl polyurethane (2-hydroxyethylurethane), and the reaction is represented by the chemical equations shown in the FIGS. 1 and 2.

FIG. 1 shows the reaction between carbon dioxide and an oxirane ring to produce cyclic carbonates. FIG. 1 depicts the reaction between carbon dioxide and the oxirane ring for both single cyclic carbonates and bicyclic carbonates. As shown in the FIG. 1, the cyclic carbonates are manufactured by a nucleophilic ring opening reaction of oxirane and carbon dioxide. The cyclic carbonate is manufactured by the reaction of oxirane with carbon dioxide in the presence of a catalyst. The catalyst can include an amine, a phosphine, a quaternary ammonium salt, an antimony compound, a porphyrin, and/or a transition metal complex. The reaction to produce the cyclic carbonate can be produced at a variety of different pressures ranging from atmospheric pressure to high pressures of 10 to 50 atmospheres. FIG. 2 shows the reaction between the cyclic carbonates and diamines to produce the non-isocyanate urethanes. A variety of reactions that result in the production of non-isocyanate urethanes are shown in the FIG. 2. As can be seen, the reaction takes place at room temperature in the presence of a solvent such as dichloromethane. The reaction can also take place at elevated temperatures if desired.

Examples of diamines that may be used in the reaction of FIG. 2 are linear aliphatic diamines (e.g., ethylenediamine (1,2-diaminoethane), drerivatives of ethylene diamines such as N-alkylated compounds (ethambutol) and tetramethylethylenediamine, propane-1,3-diamine, butane-1,4-diamine, pentane-1,5-diamine, hexamethylenediamine (hexane-1,6-diamine), or combinations thereof), branched aliphatic diamines (e.g., 1,2-diaminopropane, diphenylethylenediamine, which is C2-symmetric, diaminocyclohexane, which is C2-symmetric, or combinations thereof), xylylenediamines (e.g., o-xylylenediamine, m-xylylenediamine, p-xylylenediamine, or combinations thereof), aromatic diamines (e.g., phenylenediamines such as o-phenylenediamine or OPD, m-phenylenediamine or MPD, p-phenylenediamine or PPD, 2,5-diaminotoluene is related to PPD but contains a methyl group on the ring, various N-methylated derivatives of the phenylenediamines such as dimethyl-4-phenylenediamine, N,N′-di-2-butyl-1,4-phenylenediamine, 4,4′-diaminobiphenyl, 1,8-diaminonaphthalene, or combinations thereof), cyclic diamines, polyamines or the like, or combinations thereof.

The reactions shown in the FIGS. 1 and 2 may be conducted in a variety of different solvents such as liquid carbon dioxide, dimethylformamide, dimethylacetamide, dimethylsulfoxide, and the like. The polyurethanes thus produced may be end functionalized with a variety of different molecules. The R₁ and R₂ moieties on the non-isocyanate urethane molecule are discussed in detail below.

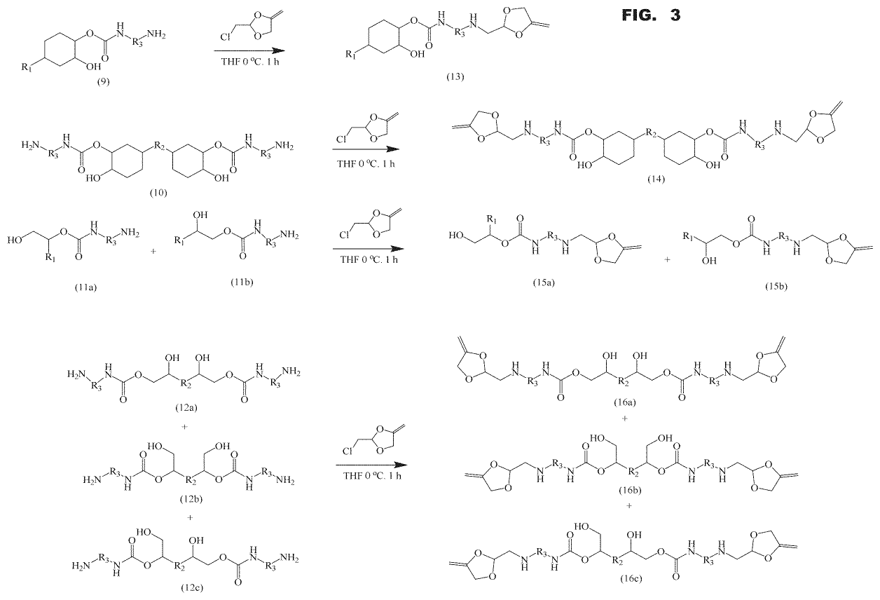

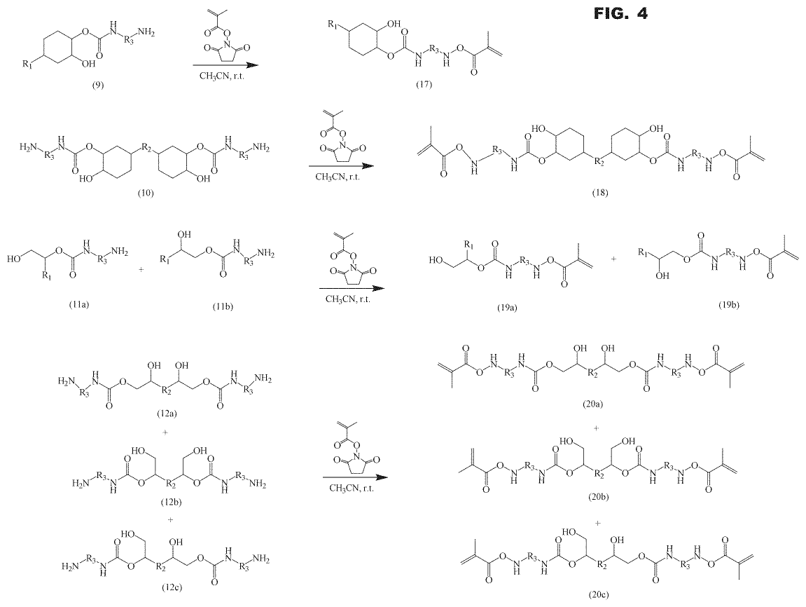

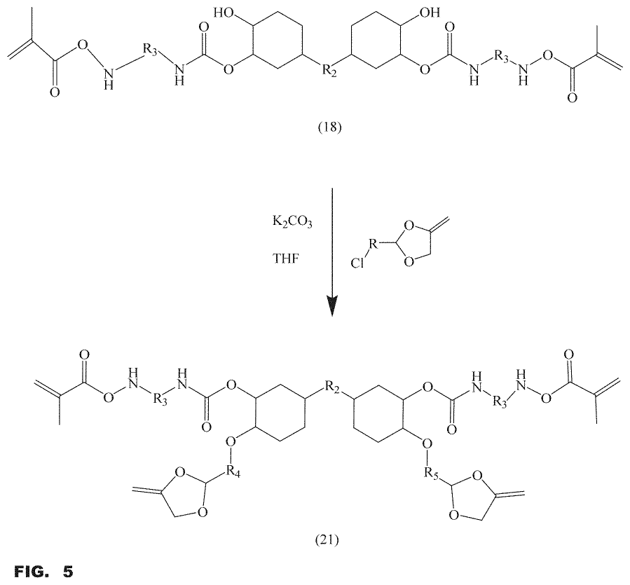

FIGS. 3-7 show a variety of different reactions that can be conducted with the non-isocyanate urethanes that impart different properties and capabilities to the molecule. The FIGS. 3 and 4 show the endcapping of the various non-isocyanate urethanes (from the FIG. 2) with 4-methylene-1,3-dioxolane.

The reaction between the 4-methylene-1,3-dioxolane and the non-isocyanate urethane can be conducted in a variety of different solvents. Liquid aprotic polar solvents such as water, propylene carbonate, ethylene carbonate, butyrolactone, acetonitrile, benzonitrile, nitromethane, nitrobenzene, sulfolane, dimethylformamide, N-methylpyrrolidone, or the like, or combinations comprising at least one of the foregoing solvents are generally desirable. Polar protic solvents such as, but not limited to, methanol, acetonitrile, nitromethane, ethanol, propanol, isopropanol, butanol, or the like, or combinations comprising at least one of the foregoing polar protic solvents may be used. Other non-polar solvents such a liquid carbon dioxide, supercritical carbon dioxide, benzene, toluene, methylene chloride, carbon tetrachloride, hexane, diethyl ether, tetrahydrofuran, or the like, or combinations comprising at least one of the foregoing solvents may also be used. Co-solvents comprising at least one aprotic polar solvent and at least one non-polar solvent may also be utilized. Ionic liquids, which mainly comprise the imidazolium salts, may also be utilized for swelling the polymer. An exemplary solvent for conducting the 4-methylene-1,3-dioxolane endcapping reaction is tetrahydrofuran (THF).

These endcapping reactions (seen in the FIGS. 3 and 4) can be conducted at temperatures of −30° C. to 100° C., and preferably −10° C. to 35° C. Reaction pressure may be varied from below atmospheric pressure (i.e., a vacuum) to pressures as high as 100 psi.

As can be seen in the FIG. 3, the 4-methylene-1,3-dioxolane reacts with the amine functionality at the end of the non-isocyanate urethane molecule to endcap the molecule. In the FIG. 4, the 4-methylene-1,3-dioxolane molecule is reacted with the hydroxyl functionality on the cyclohexyl ring. In the FIG. 4, it may also be seen that the non-isocyanate urethane is methacrylate endcapped prior to being reacted with the 4-methylene-1,3-dioxolane molecule.

The urethanes of the FIG. 3 and FIG. 4 are shown below in the formulas (I) through (XIV)

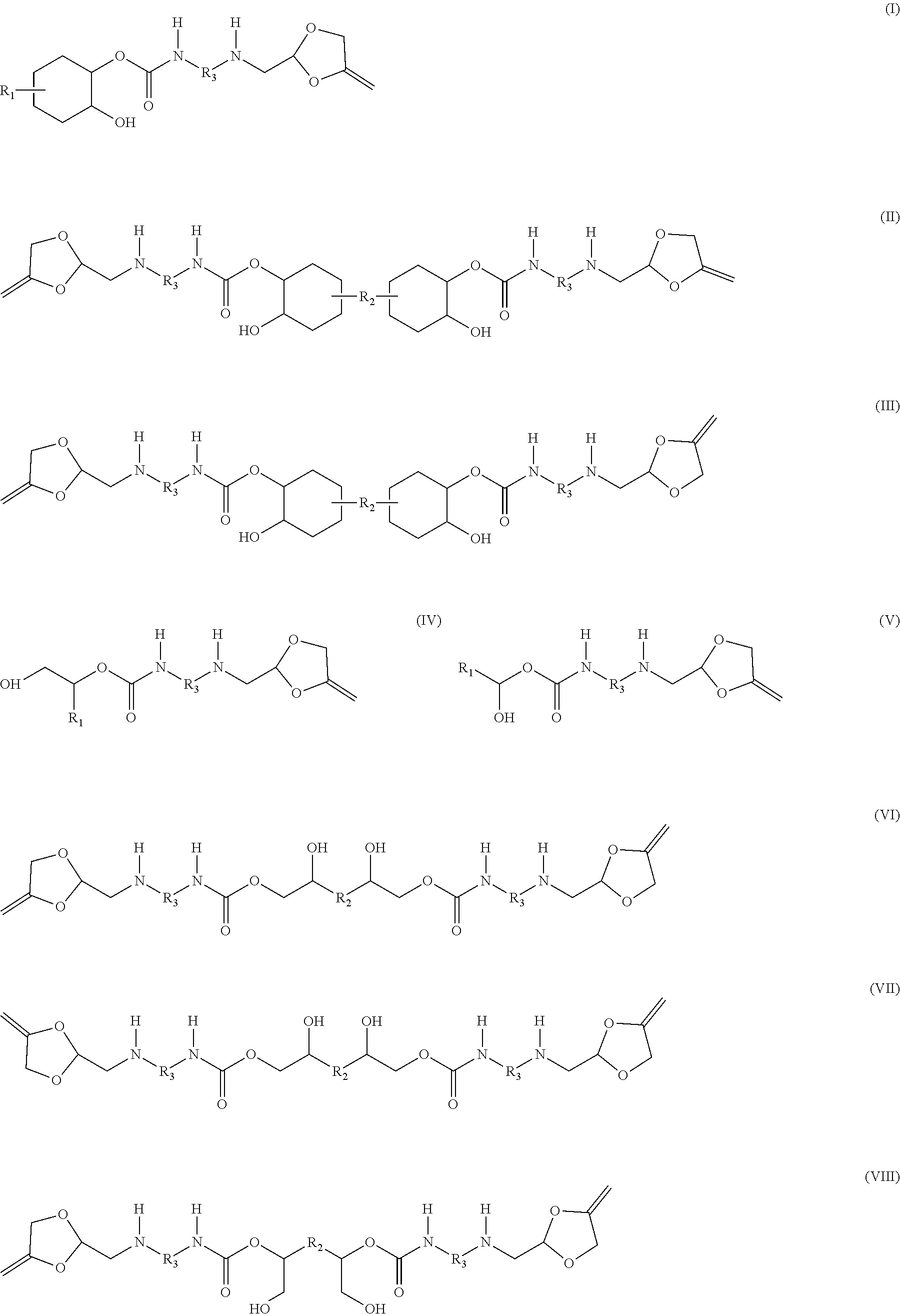

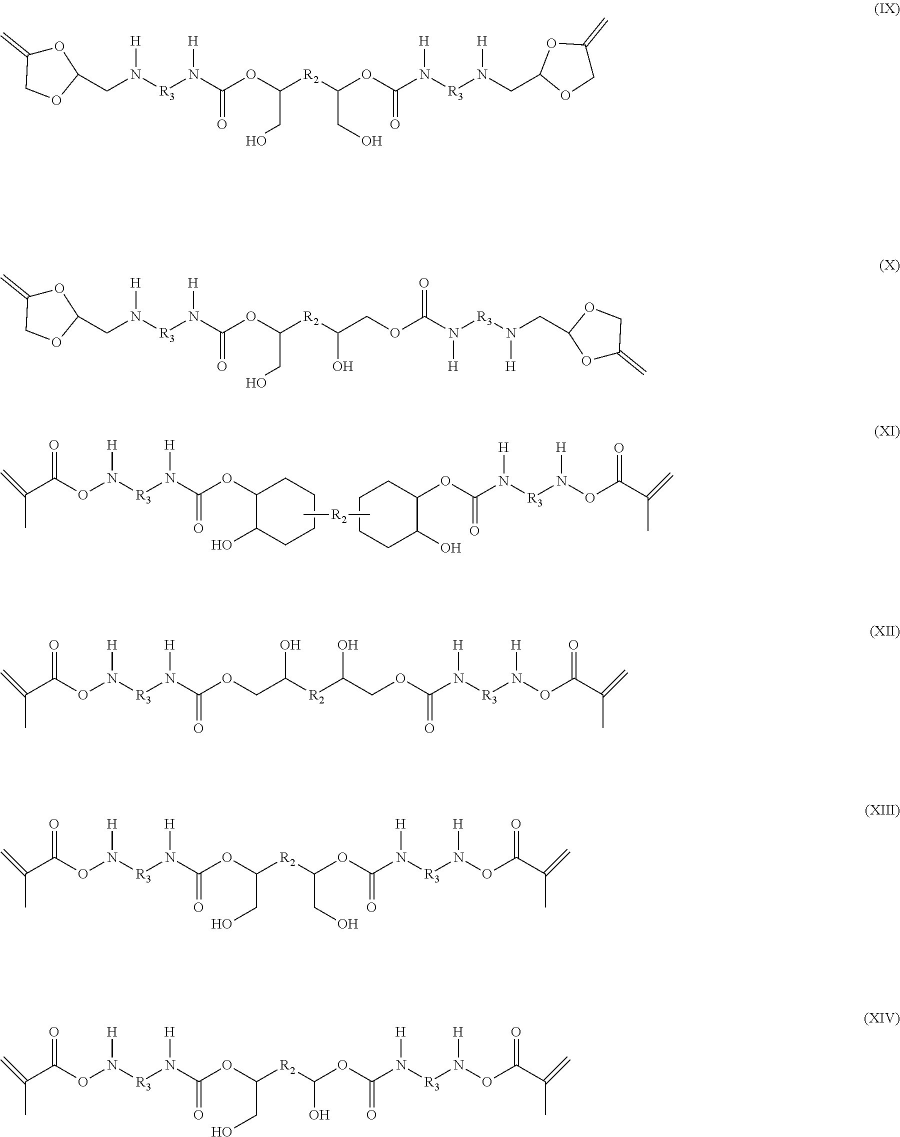

where hydroxyl or amine linkages on the urethane of formulas (I) through (XIV) are functionalized with molecules that contain fluorine atoms, phosphorus atoms, sulfur atoms, unsaturated carboxylic acids, derivatives of unsaturated carboxylic acids, or combinations thereof.

In the formulas (I) through (XIV), the bridging moieties R₁, R₂ and R₃ can be a straight chain or branched C₁₋₃₀ alkyl, a C₃₋₃₀ cycloalkyl, a C₆₋₃₀ aryl, C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl or a combination comprising at least one of these groups. Other definitions for the bridging moieties R₁, R₂ and R₃ are detailed below.

The functionalization of the non-isocyanate urethane with the 4-methylene-1,3-dioxolane provides the non-isocyanate urethane molecule with ring opening capabilities that can be further used to crosslink the molecule. 4-methylene-1,3-dioxolane endcapped polyurethanes can thus be used as dental resins. In addition, by using the appropriate substituents for the functional group R1 (in the FIG. 3), dendritic molecules can be produced.

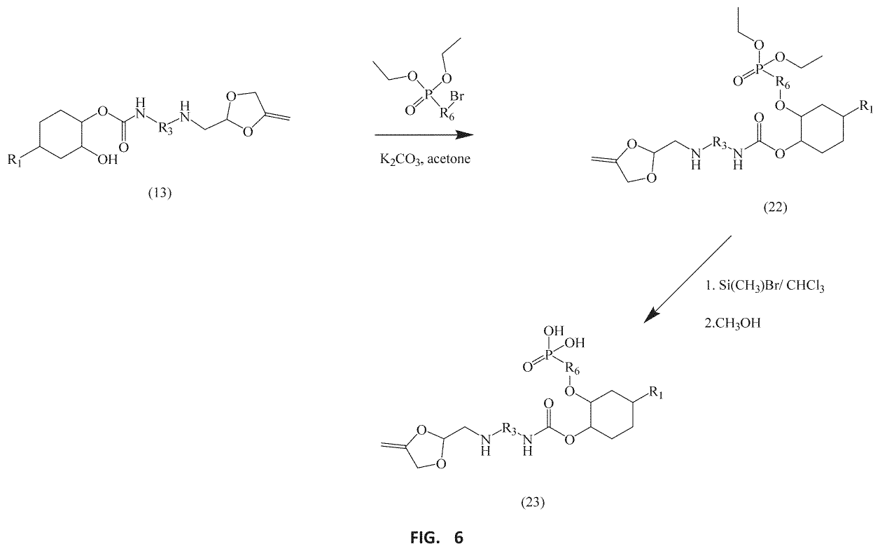

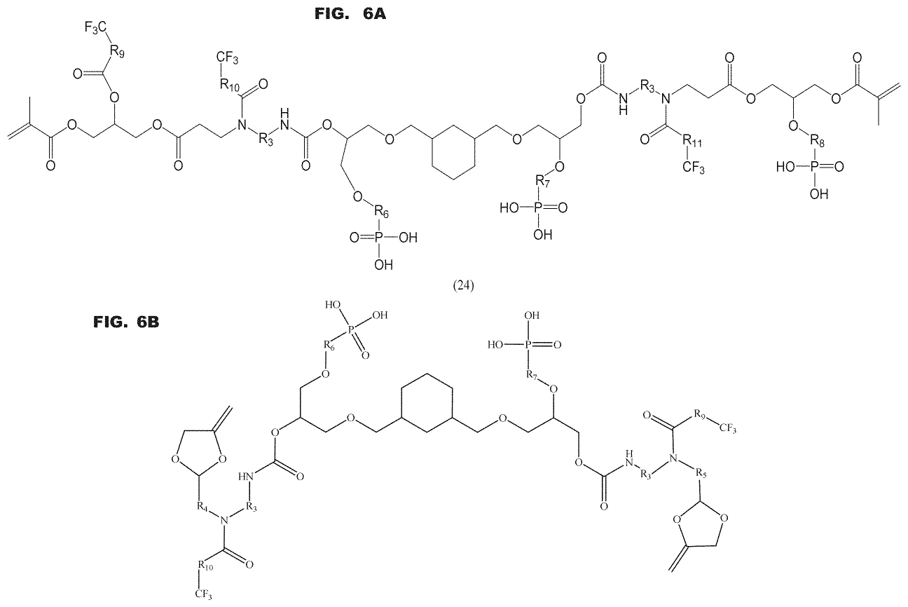

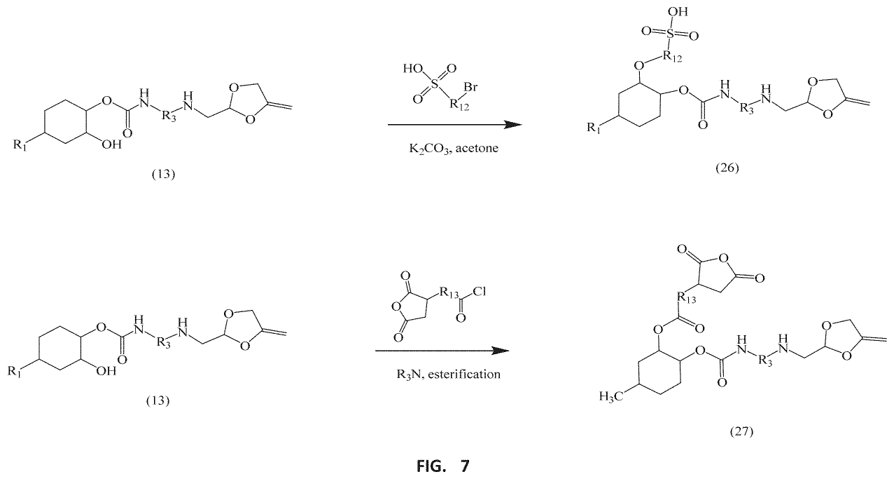

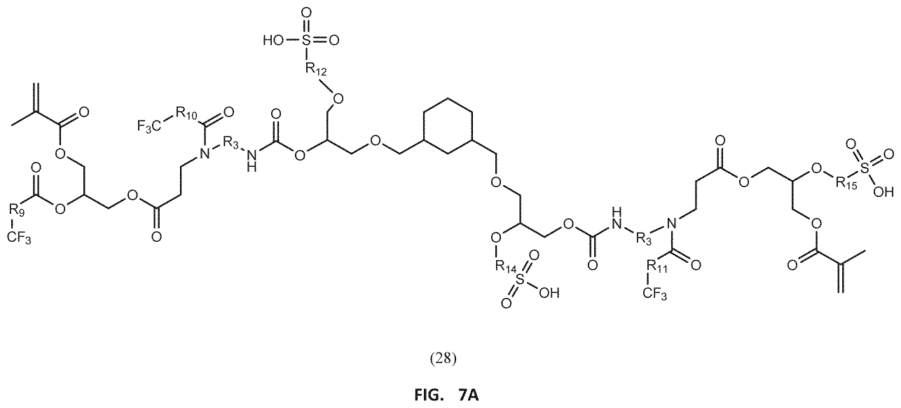

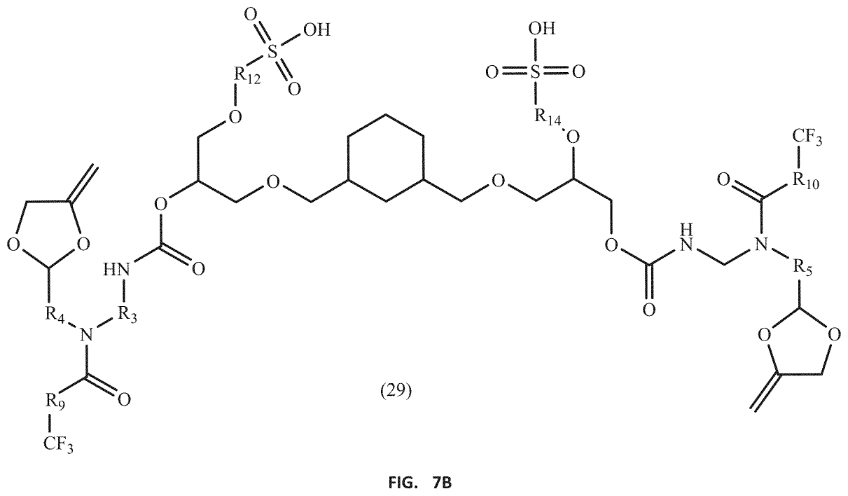

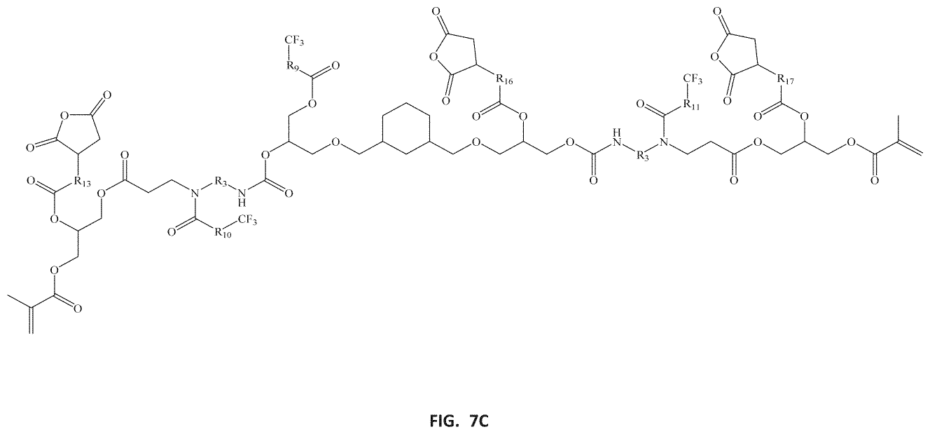

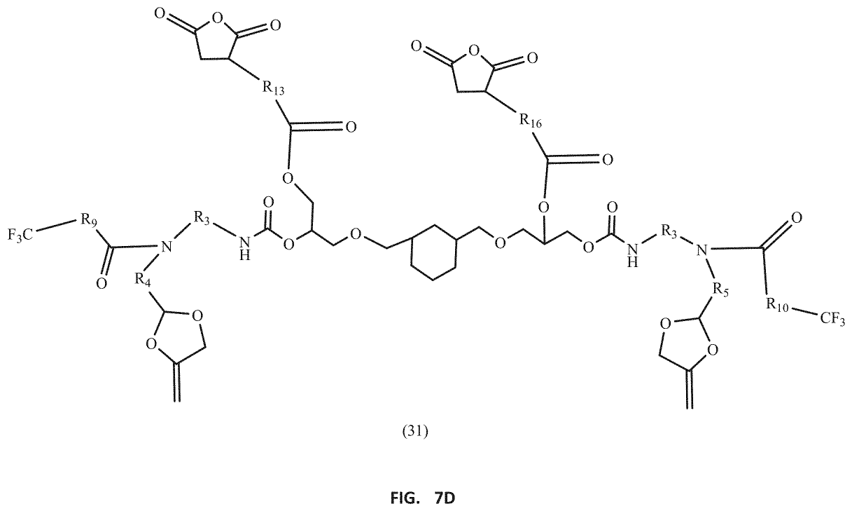

The FIGS. 5-7 shows the functionalization of the non-isocyanate urethane with methacrylates, phosphoric acid, sulfonic acid or an anhydride. As noted above, the functionalization can be conducted at the amine functionalized end of the non-isocyanate urethane molecule or at the hydroxyl moiety on the cyclohexyl molecule. While the FIGS. 5-7 show that the hydroxyl moiety is at the para-position with regard to the bridging moiety R₁, it is envisioned that the hydroxyl moiety can be located at the ortho or meta positions and can be reacted with other functional molecules such as, for example, those shown in the FIGS. 5-7. It is to be noted that the FIG. 5 depicts the end functionalization of the non-isocyanate urethane with a methacrylate functionality prior to functionalization with the 4-methylene-1,3-dioxolane molecule. FIG. 6(A) shows the functionalization of the a fluorinated non-isocyanate urethane dioxolane from the FIG. 3 with phosphoric acid; FIGS. 7(A) and 7 (B) show the functionalization of a fluorinated non-isocyanate urethane dioxolane with sulfonic acid; and the FIGS. 7(C) and 7(D) show the functionalization of a fluorinated non-isocyanate urethane dioxolane with any anhydride.

In one embodiment, the non-isocyanate urethane can be functionalized with unsaturated carboxylic acids are maleic acid, fumaric acid, itaconic add, acrylic acid, methacrylic acid, crotonic acid, and citraconic acid. Examples of derivatives of unsaturated carboxylic acids are maleic anhydride, citraconic anhydride, itaconic anhydride, methyl acrylate, methyl methacrylate, ethyl acrylate, ethyl methacrylate, butyl acrylate, butyl methacrylate, glycidyl acrylate, glycidyl methacrylate, or the like, or a combination thereof. Maleic anhydride is the preferred grafting compound for functionalizing the non-isocyanate urethanes.

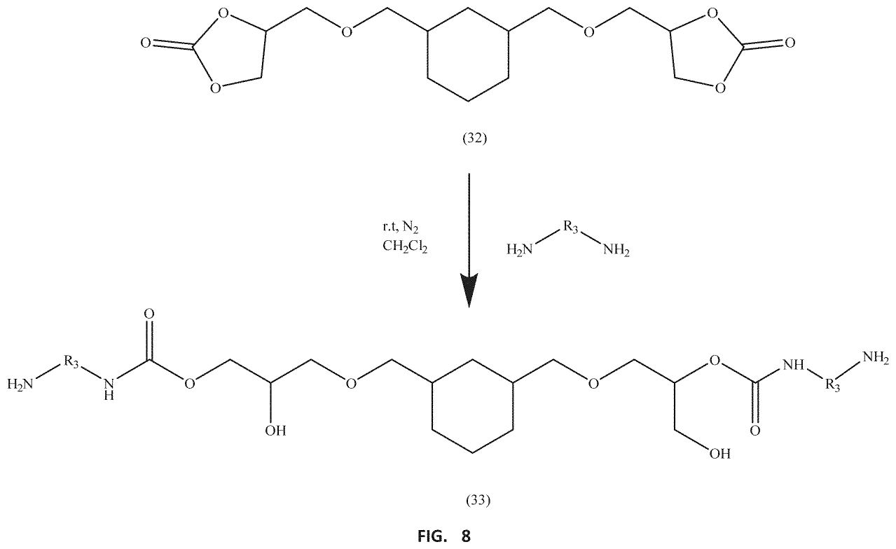

In one exemplary embodiment, the non-isocyanate urethane can be functionalized with molecules that have fluorine atoms to provide the polyurethanes with unique functional properties. These polyurethanes are called fluorinated non-isocyanate urethane dimethacrylate resins and can be used in a variety of different applications. The manufacturing of these fluorinated non-isocyanate urethane dimethacrylate resins is detailed in the FIGS. 8-10.

In the FIG. 8, the cyclic carbonate is reacted with a cyclic isophorondiamine to produce an asymmetric non-isocyanate urethane that is endcapped with the cyclic diamine. The FIG. 8 depicts one method of endcapping the cyclic carbonate with a cyclic diamine. The cyclic diamine is 5-amino-1,3,3-trimethylcyclohexanemethylamine (IPDA).

The reaction is conducted in the presence of a dichloromethane solvent and the reactants are covered in a blanket of nitrogen during the reaction. About 0.5 to 2.3 moles of the diamine are used per mole of the cyclic carbonate. The reaction temperature is 0 to 70° C., preferably 20 to 30° C. and the reaction pressure is 0.1 atmosphere to 20 atmospheres, preferably 1 to 2 atmospheres. The reaction may be conducted in a batch or in a continuous reactor, preferably in a batch reactor. It is to be noted that other solvents listed above may also be used in lieu of or in conjunction with the dichloromethane.

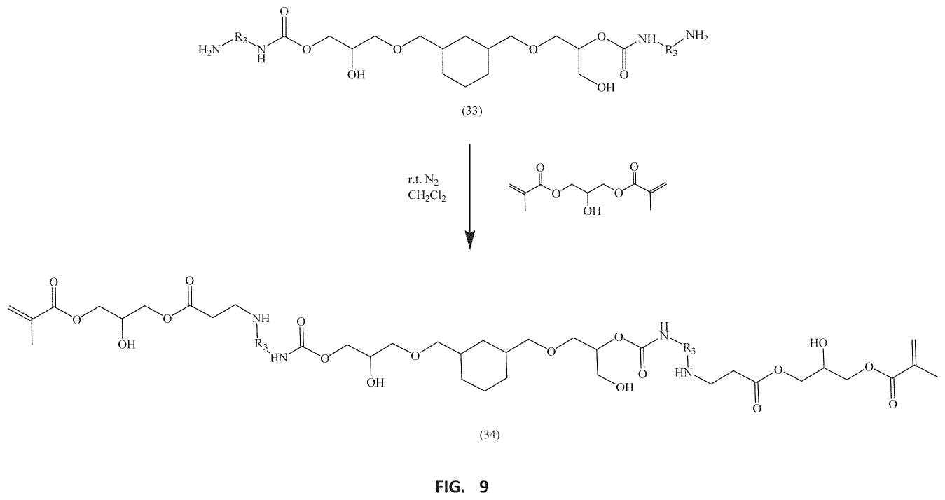

The non-isocyanate urethane functionalized with the cyclic isophorondiamine of the FIG. 8 is then reacted with a methacrylate (3-acryloyloxy-2-hydroxypropyl methacrylate (AHM)) in the presence of dichloromethane under a blanket of nitrogen as shown in the FIG. 9 to form a dimethacrylate functionalized urethane. With reference to the FIG. 9, about 1.9 to 2.3 moles of the dimethacrylate are used per mole of the non-isocyanate urethane. The reaction temperature is −10 to 70° C., preferably 20 to 30° C. and the reaction pressure is 0.1 atmosphere to 20 atmospheres, preferably 1 to 2 atmospheres. The reaction may be conducted in a batch or in a continuous reactor, preferably in a batch reactor. In an embodiment, the reaction of the FIG. 9 can be conducted in the same reactor as that of the FIG. 8. The reaction of the FIG. 8 is detailed in U.S. Patent Publication No. 20130004467 to Jing-Zhong Hwang et al., the entire contents of which are hereby incorporated by reference.

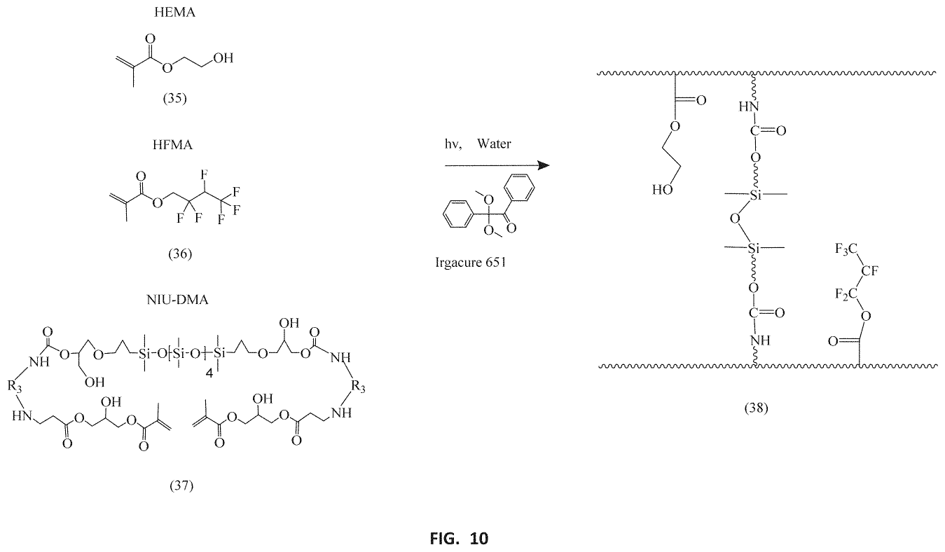

The dimethacrylate functionalized urethane of the FIG. 9 can be cured using radiation or can be cured thermally to create a hydrogel. Radiation includes ultraviolet radiation, microwave radiation, xray radiation, electron beam radiation and the like. The FIG. 10 shows how the dimethacrylate functionalized urethane of the FIG. 9 (optionally containing a polydimethylsiloxane molecule) may be mixed with other methacrylates such as hydroxyethylmethacrylate (HEMA) and hexafluorobutyl methacrylate (HFMA) to form a mixture. The mixture can then be applied to a surface and then irradiated to form a hydrogel. By varying the ratio of HFMA to HEMA and the dimethacrylate functionalized urethane, the hydrophobicity of the surface can be controlled. In addition, by varying the amount of the optional polysiloxane in the dimethacrylate functionalized urethane, the hydrophobicity of the surface can also be controlled.

In a hydrogel formulation, the HEMA is present in an amount of 50 to 90 mole percent, preferably 60 to 80 mole percent, based upon the total number of moles of the composition. The HFMA is present in an amount of 5 to 30 mole percent, preferably 10 to 20 mole percent, based upon the total number of moles of the composition. The dimethacrylate functionalized urethane is present in an amount of 5 to 20, preferably 6 to 15 mole percent based upon the total number of moles of the hydrogel composition. The hydrogel composition may use a catalyst, an initiator and/or a curing agent as desired.

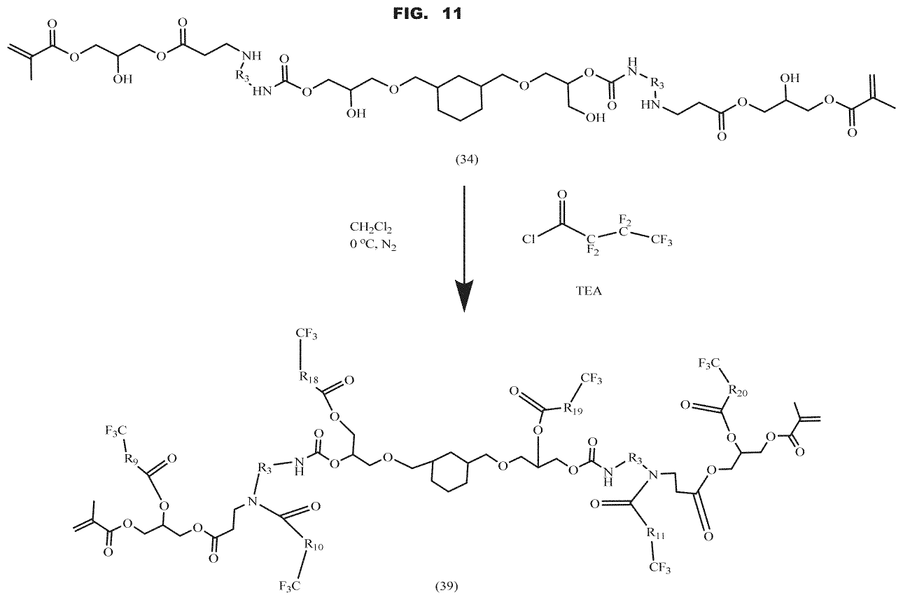

In one embodiment, the dimethacrylate functionalized urethane can be functionalized with a fluorine containing molecule to form the fluorinated non-isocyanate urethane methacrylate. The FIG. 11 depicts the functionalization of the dimethacrylate functionalized urethane to form the fluorinated non-isocyanate urethane methacrylate. The reaction of the FIG. 11 is conducted in the presence of dichloromethane under a blanket of nitrogen. With reference to the FIG. 11, about 0.1 to 7.2 moles of the fluorine containing molecule are used per mole of the dimethacrylate functionalized urethane. In one embodiment, the fluorine containing molecule is perfluorobutyryl chloride. The reaction temperature is −10 to 70° C., preferably −5 to 10° C. and the reaction pressure is 0.1 atmosphere to 20 atmospheres, preferably 1 to 2 atmospheres. The reaction may be conducted in a batch or in a continuous reactor, preferably in a batch reactor. In an embodiment, the reaction of the FIG. 11 can be conducted in the same reactor as that of the FIG. 9.

With regard to the FIG. 11, it may be seen that that the fluorine containing molecule can react with the dimethacrylate functionalized urethane at either the hydroxyl moiety or at the amine moiety. In one embodiment, some of the hydroxyl moieties (on the dimethacrylate functionalized urethane) can be reacted with the fluorine containing molecules with other can be reacted with molecules that contain phosphorus, silicon, sulfur, boron, and the like. Some of these alternative functionalization schemes are shown in the FIGS. 5-7. In another embodiment, some of the amine moieties (on the dimethacrylate functionalized urethane) can be reacted with the fluorine containing molecules with other can be reacted with molecules that contain phosphorus, silicon, sulfur, and the like. Some of these alternative functionalization schemes are shown in the FIGS. 5-7 above.

The fluorinated non-isocyanate urethane methacrylate can be used in a variety of different applications. In one embodiment depicted in the FIG. 11, it can be used to coat surfaces and to control the hydrophobicity of the surface.

With reference now once again to the FIGS. 1-3, it may be seen that the bridging moieties R₁, R₂ and R₃ can be selected from a variety of different organic molecules. The bridging moieties R₁, R₂ and R₃ can be selected from a variety of different organic groups that are shown below.

R₁ and/or R₂ and/or R₃ in the FIGS. 1-3 may be an aromatic organic group, for example, a group of the formula (1):

-A¹-Y¹-A²- (1)

wherein each of the A¹ and A² is an alkyl group, a cycloalkyl group or a monocyclic divalent aryl group and Y¹ is a bridging group that separates A¹ and A². In one embodiment, Y¹ can comprise one or two atoms. For example, one atom may separate A¹ from A², with illustrative examples of these groups including —O—, —S—, —S(O)—, —S(O)₂)—, —C(O)—, methylene, cyclohexyl-methylene, 2-[2.2.1]-bicycloheptylidene, ethylidene, isopropylidene, neopentylidene, cyclohexylidene, cyclopentadecyclidene, cyclododecylidene, and adamantylidene. The bridging group of Y¹ may be a hydrocarbon group or a saturated hydrocarbon group such as methylene, cyclohexlylidene, or isopropylidene.

In another embodiment, the bridging group Y¹ may contain 3 or more atoms. Examples of bridging groups that contain 3 or more atoms are C₂ to C₁₈ alkyl groups, C₃ to C₁₈ cycloalkyl groups, fused aryl groups, polymeric molecules and the like. Further details are provided below.

In one embodiment, R₁ may be derived from dihydroxy compounds having the formula HO—R₁—OH, wherein R₁ is defined as above for formula (1). The formula HO—R₁—OH includes bisphenol compounds of the formula (2):

HO-A¹-Y¹-A²-OH (2)

wherein Y¹, A¹, and A² are as described above. For example, one atom may separate A¹ and A². Each R₁ may include bisphenol compounds of the general formula (3):

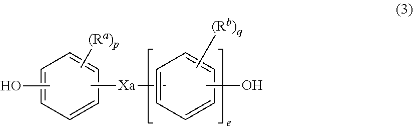

where Xₐ is a bridging group connecting the two hydroxy-substituted aromatic groups, where the bridging group and the hydroxy substituent of each C₆ arylene group are disposed ortho, meta, or para (specifically para) to each other on the C₆ arylene group. For example, the bridging group Xₐ may be single bond, —O—, —S—, —C(O)—, or a C₁₋₁₈ organic group. The C₁₋₁₈ organic bridging group may be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. R^{a} and R^{b} may each represent a halogen, C₁₋₁₂ alkyl group, or a combination thereof. For example, R^{a} and R^{b} may each be a C₁₋₃ alkyl group, specifically methyl, disposed meta to the hydroxy group on each arylene group. The designation (e) is 0 or 1. The numbers p and q are each independently integers of 0 to 4. It will be understood that R^{a} is hydrogen when p is 0, and likewise R is hydrogen when q is 0.

Xₐ may be substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. This may include methylene, cyclohexylmethylene, ethylidene, neopentylidene, isopropylidene, 2-[2.2.1]-bicycloheptylidene, cyclohexylidene, cyclopentylidene, cyclododecylidene, and adamantylidene. A specific example wherein Xₐ is a substituted cycloalkylidene is the cyclohexylidene-bridged, alkyl-substituted bisphenol of formula (4):

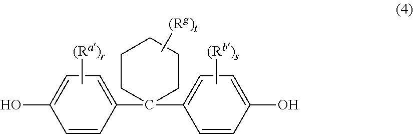

wherein R^{a} and R^{b} are each independently C₁₋₁₂ alkyl, R⁹ is C₁₋₁₂ alkyl or halogen, r and s are each independently 1 to 4, and t is 0 to 10. R^{a′} and R^{b′} may be disposed meta to the cyclohexylidene bridging group. The substituents R^{a′}, R^{b′} and R^{g} may, when comprising an appropriate number of carbon atoms, be straight chain, cyclic, bicyclic, branched, saturated, or unsaturated. For example, R⁹ may be each independently C₁₋₄ alkyl, R^{g} is C₁₋₄ alkyl, r and s are each 1, and t is 0 to 5. In another example, R^{a′}, R^{b′} and R^{g} may each be methyl, r and s are each 1, and t is 0 or 3. The cyclohexylidene-bridged bisphenol can be the reaction product of two moles of o-cresol with one mole of cyclohexanone. In another example, the cyclohexylidene-bridged bisphenol may be the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol-containing polycarbonates, or a combination comprising at least one of the foregoing with other bisphenol polycarbonates, are supplied by Bayer Co. under the APEC® trade name.

In one embodiment, Xₐ is a C₁₋₁₈ alkylene group, a C₃₋₁₈ cycloalkylene group, a fused C₆₋₁₈ cycloalkylene group, or a group of the formula —B₁—W—B₂— wherein B₁ and B₂ are the same or different C₁₋₆alkylene group and W is a C₃₋₁₂ cycloalkylidene group or a C₆₋₁₆ arylene group.

In another example, Xₐ may be a substituted C₃₋₁₈ cycloalkylidene of the formula (5):

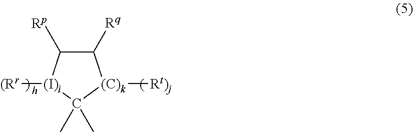

wherein R^{r}, R^{p}, R^{q}, and R^{t} are independently hydrogen, halogen, oxygen, or C₁₋₁₂ organic groups; I is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; h is 0 to 2, j is 1 or 2, i is an integer of 0 or 1, and k is an integer of 0 to 3, with the proviso that at least two of R^{r}, R^{p}, R^{q} and R^{t} taken together are a fused cycloaliphatic, aromatic, or heteroaromatic ring. It will be understood that where the fused ring is aromatic, the ring as shown in formula (5) will have an unsaturated carbon-carbon linkage at the junction where the ring is fused. When i is 0, h is 0, and k is 1, the ring as shown in formula (5) contains 4 carbon atoms; when i is 0, h is 0, and k is 2, the ring as shown contains 5 carbon atoms, and when i is 0, h is 0, and k is 3, the ring contains 6 carbon atoms. In one example, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

Other useful dihydroxy compounds having the formula HO—R₁—OH include aromatic dihydroxy compounds of formula (6):

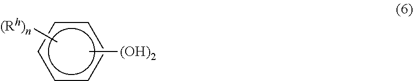

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

Bisphenol-type dihydroxy aromatic compounds may include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxy-3 methyl phenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as a combination comprising at least one of the foregoing dihydroxy aromatic compounds.

Examples of the types of bisphenol compounds represented by formula (2) may include 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PBPP”), 9,9-bis(4-hydroxyphenyl)fluorene, and 1,1-bis(4-hydroxy-3-methylphenyl)cyclohexane (“DMBPC”). Exemplary polymers and copolymers (that are used in the R₁ position) containing polycarbonate units may be derived from bisphenol A.

As detailed above, R₁ can be a polymer. In one embodiment, R₁ is a polyolefin, a polycarbonate, a polyalkylene glycol, a polyester-carbonate, a polysiloxane, a polycarbonate-siloxane, a poly(meth)acrylate, a poly(meth)acrylate-siloxane, a polyalkyl(meth)acrylate, a polyalkyl(meth)acrylate-siloxane, a polyetherketone, a polysulfone, a polyphosphazene, a polyphosphonate, a polyimide, a polyetherimide, a polyacetal, a polyacrylic, a polystyrene, a polyester, a polyamide, a polyamideimide, a polyarylate, a polyarylsulfone, a polyethersulfone, a polyphenylene sulfide, a polyvinyl chloride, a polyfluoroethylene, a polyether etherketone, a polyether ketone ketone, a polybenzoxazole, a polyoxadiazole, a polybenzothiazinophenothiazine, a polybenzothiazole, a polypyrazinoquinoxaline, a polypyromellitimide, a poly quinoxaline, a poly benzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polypyrrolidine, a polycarborane, a polyoxabicyclononane, a polydibenzofuran, a polyphthalide, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfonamide, a polyurea, a polyphosphazene, a polysilazane, or the like, or a combination thereof.

Resorbable or biodegradable polymers may also be used. These include polylactic-glycolic acid (PLGA), poly-caprolactone (PCL), copolymers of polylactic-glycolic acid and poly-caprolactone (PCL-PLGA copolymer), polyhydroxy-butyrate-valerate (PHBV), polyorthoester (POE), polyethylene oxide-butylene terephthalate (PEO-PBTP), poly-D,L-lactic acid-p-dioxanone-polyethylene glycol block copolymer (PLA-DX-PEG), or the like, or a combination thereof.

In one embodiment, R₁ or R₂ or R₃ is preferably a polycarbonate, a polysiloxane, a polyester carbonate, a polycarbonate-siloxane or a polyester-siloxane. In an embodiment, the polysiloxane is represented by the formula (7):

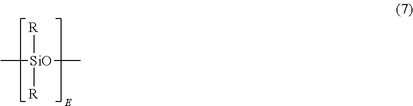

wherein each R is independently a C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. Combinations of the foregoing R groups can be used in the same copolymer.

The value of E in formula (7) can vary widely depending on the type and relative amount of each component in the flame retardant composition, the desired properties of the composition, and like considerations. Generally, E has an average value of 2 to 1,000, specifically 3 to 500, more specifically 5 to 100. Polysiloxane-carbonate copolymers may also be used in the R₁ or R₂ or R₃ positions.

As noted above, R₁ or R₂ or R₃ may be a polyestercarbonate, also known as a polyester-polycarbonate. The polycarbonate portion may be defined as follows in the formula (8:

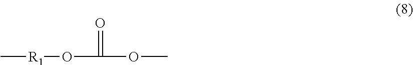

where R₁ is the dihydroxy compound as defined above in the formulas (1), (2) or (6) and wherein at least 60 percent of the total number of R¹ groups may contain aromatic organic groups and the balance thereof are aliphatic or alicyclic, or aromatic groups.

In another embodiment, R₁ and/or R₂ and/or R₃ is a polyester carbonate as shown in the formula (9)

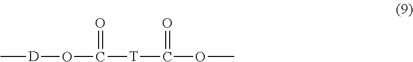

wherein O-D-O is a divalent group derived from a dihydroxy compound, and D may be, for example, one or more alkyl containing C₆-C₂₀ aromatic group(s), or one or more C₆-C₂₀ aromatic group(s), a C₂₋₁₀ alkylene group, a C₆₋₂₀ alicyclic group, a C₆₋₂₀ aromatic group or a polyoxyalkylene group in which the alkylene groups contain 2 to 6 carbon atoms, specifically 2, 3, or 4 carbon atoms. D may be a C₂₋₃₀ alkylene group having a straight chain, branched chain, or cyclic (including polycyclic) structure. O-D-O may be derived from the formulas (1), (2) and (6) above. T of formula (8) may be a divalent group derived from a dicarboxylic acid, and may be, for example, a C₂₋₁₀ alkylene group, a C₆₋₂₀ alicyclic group, a C₆₋₂₀ alkyl aromatic group, a C₆₋₂₀ aromatic group, or a C₆ to C₃₆ divalent organic group derived from a dihydroxy compound or chemical equivalent thereof. In an embodiment, T is an aliphatic group. T may be derived from a C₆-C₂₀ linear aliphatic alpha-omega (α-Ω) dicarboxylic ester. Diacids from which the T group in the ester unit of formula (8) is derived include aliphatic dicarboxylic acid from 6 to 36 carbon atoms, optionally from 6 to 20 carbon atoms. The C₆-C₂₀ linear aliphatic alpha-omega (αΩ) dicarboxylic esters may be derived from adipic acid, sebacic acid, 3,3-dimethyl adipic acid, 3,3,6-trimethyl sebacic acid, 3,3,5,5-tetramethyl sebacic acid, azelaic acid, dodecanedioic acid, dimer acids, cyclohexane dicarboxylic acids, dimethyl cyclohexane dicarboxylic acid, norbornane dicarboxylic acids, adamantane dicarboxylic acids, cyclohexene dicarboxylic acids, C₁₄, C₁₈ and C₂₀ diacids.

While the FIGS. 1-3 do not reflect a fluorinated non-isocyanate urethane dimethacrylate resin, it can be envisioned that the methacrylate functionalized urethanes of the FIG. 3 can be fluorinated as detailed in the FIG. 10 while at the same time having R₁, R₂ and R₃ selected from amongst the foregoing functional groups. In an exemplary embodiment, the bridging moiety R₁, R₂ and/or R₃ is a polysiloxane.

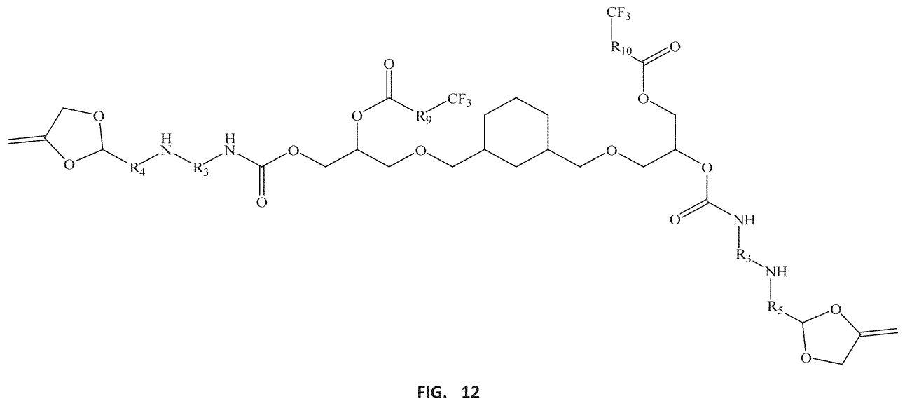

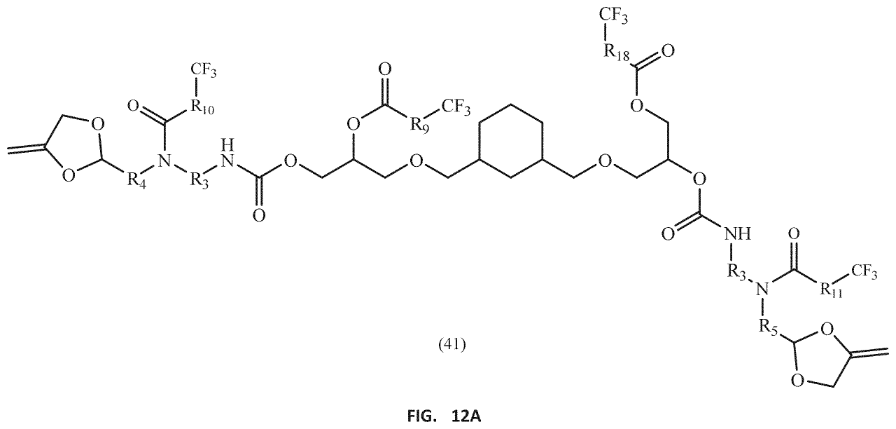

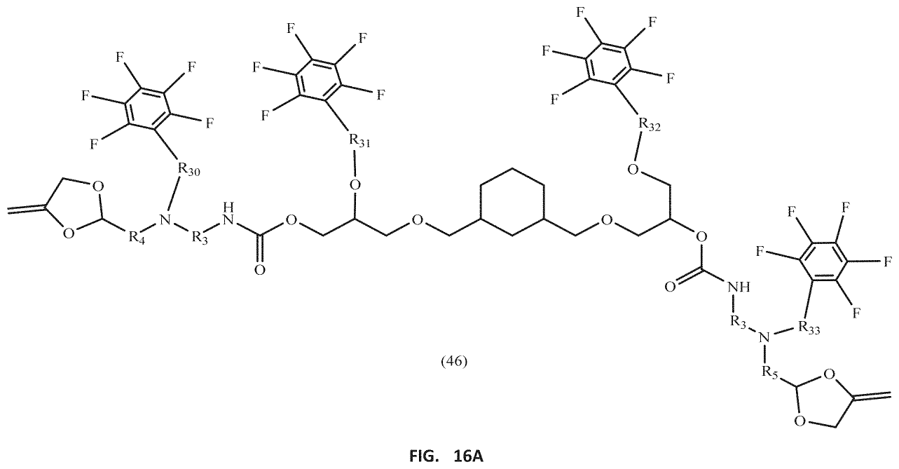

FIGS. 12-19 show various exemplary structures of non-isocyanate acrylates functionalized with fluorine containing molecules, sulfur containing molecules, phosphorus containing molecules and anhydride functionalized molecules. In the FIGS. 12-19A, R₃ through R₄₁ may be a straight chain or branched C₁₋₃₀ alkyl, a C₃₋₃₀ cycloalkyl, a C₆₋₃₀ aryl, C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl, a C₁₋₃₀ fluoroalkyl, a C₃₋₃₀ cyclofluoroalkyl, a C₆₋₃₀ aryl where 1 to 5 hydrogen atoms are fluoro-substituted, C₇₋₃₀ fluoro-substituted alkaryl, a C₇₋₃₀ fluoro-substituted aralkyl, a C₁₋₃₀ fluoro-substituted heteroalkyl, a C₃₋₃₀ fluoro-substituted heterocycloalkyl, a C₆₋₃₀ fluoro-substituted heteroaryl, a C₇₋₃₀ fluoro-substituted heteroalkaryl, or a combination comprising at least one of these groups. Preferred values for R₃ through R₄₁ are shown in the Table 1 below.

The fluorinated non-isocyanate urethane dimethacrylate resin may be used to manufacture a variety of different articles. In one embodiment, the fluorinated non-isocyanate urethane dimethacrylate resin may be used as a coating to control the hydrophobicity/hydrophilicity of surfaces. In another embodiment, the fluorinated non-isocyanate urethane dimethacrylate resin may be partially functionalized with phosphoric acid to impart flame retardancy to other compositions that contain it. In yet another embodiment, the urethane functionalized methacrylate (without the fluorine) can be partially or fully functionalized with phosphoric acid to impart flame retardancy to other compositions that contain it. Such a flame retardant composition could be made so as to be devoid of halogens. The use of polysiloxanes as R₁ and/or R₂ may be used for the production of non-stick article surfaces if desired.

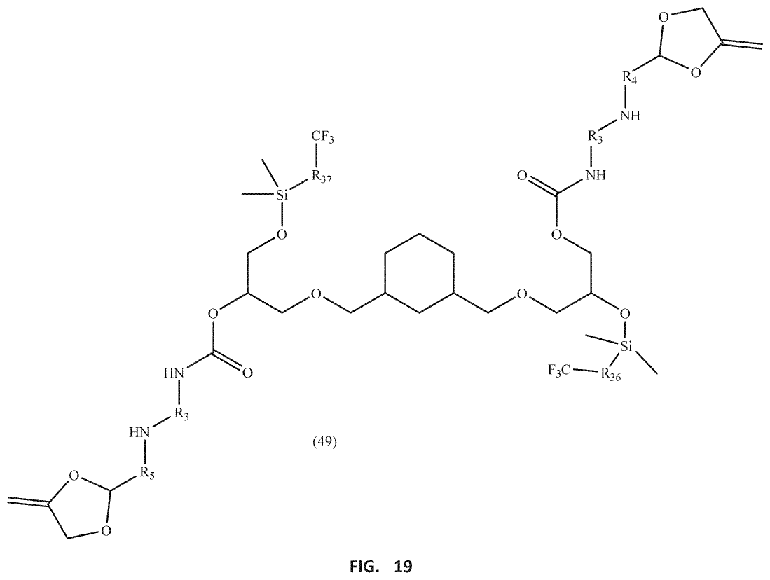

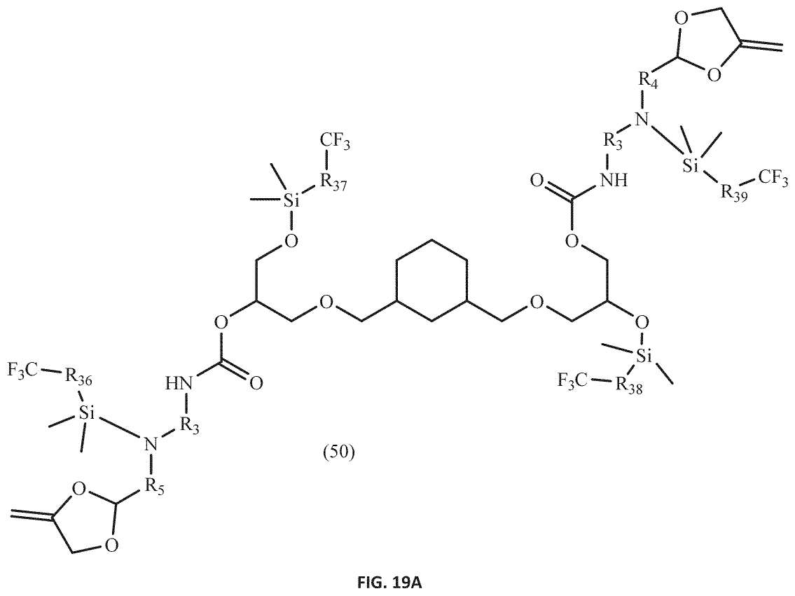

FIGS. 1-19A show various structures labelled 1, 2, 3, and so on till structure 50 in the FIG. 19A. These structures have various groups labelled R₁, R₂, R₃, and so on till R₄₁ in the FIG. 18. Preferred molecules for each of the structures R₁, R₂, R, and so on till R₄₁ are shown in the Table 1 below.

TABLE 1

| FIG. | Designation | Preferred | Chemical Name |
|---|---|---|---|
| 1 | | | |
| | R₁ | CH₃ | Methyl |
| | R₂ | CH₂ | Methylene |
| 2 | | | |
| | R₃ | 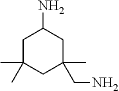 | 5-amino-1,3,3- trimethyl(cyclohexane methylamine) |
| 5 | | | |
| | R₄ | CH₂ | Methylene |
| | R₅ | CH₂ | Methylene |
| 6 | | | |
| | R₆ | (CH₂)₄ | Butylene |
| 6A | | | |
| | R₇ | (CH₂)₄ | Butylene |
| | R₈ | (CH₂)₄ | Butylene |
| | R₉ | CF2-CF2 | Tetrafluoroethylene |
| | R₁₀ | CF2-CF2 | Tetrafluoroethylene |
| | R₁₁ | CF2-CF2 | Tetrafluoroethylene |
| 7 | | | |
| | R₁₂ | (CH₂)₃ | Propylene |
| | R₁₃ | CH₂ | Methylene |
| 7A | | | |
| | R₁₄ | (CH₂)₄ | Butylene |
| | R₁₅ | (CH₂)₄ | Butylene |
| 7C | | | |
| | R₁₆ | CH₂ | Methylene |
| | R₁₇ | CH₂ | Methylene |
| 11 | | | |
| | R₁₈ | CF₂-CF₂ | Tetrafluoroethylene |
| | R₁₉ | CF₂-CF₂ | Tetrafluoroethylene |
| | R₂₀ | CF₂-CF₂ | Tetrafluoroethylene |
| 13 | | | |
| | R₂₁ | (CH₂)₄ | Butylene |
| | R₂₂ | (CH₂)₄ | Butylene |
| | R₂₃ | (CH₂)₄ | Butylene |
| 14 | | | |
| | R₂₄ | CH₂ | Methylene |
| | R₂₅ | CH₂ | Methylene |
| | R₂₆ | CH₂ | Methylene |
| 15 | | | |
| | R₂₇ | (CH₂)₄ | Butylene |
| | R₂₈ | (CH₂)₄ | Butylene |
| | R₂₉ | (CH₂)₄ | Butylene |
| 16 | | | |
| | R₃₀ | CH₂ | Methylene |
| | R₃₁ | CH₂ | Methylene |
| 16A | | | |
| | R₃₂ | CH₂ | Methylene |
| | R₃₃ | CH₂ | Methylene |
| 17 | | | |
| | R₃₄ | CH₂ | Methylene |
| | R₃₅ | CH₂ | Methylene |
| 18 | | | |
| | R₃₆ | CF₂-CF₂ | Tetrafluoroethylene |
| | R₃₇ | CF₂-CF₂ | Tetrafluoroethylene |
| | R₃₈ | CF₂-CF₂ | Tetrafluoroethylene |
| | R₃₉ | CF₂-CF₂ | Tetrafluoroethylene |
| | R₄₀ | CF₂-CF₂ | Tetrafluoroethylene |
| | R₄₁ | CF₂-CF₂ | Tetrafluoroethylene |

As stated above, FIGS. 1-19A show various structures labelled 1, 2, 3, and so on till structure 50 in the FIG. 19A. The names of these structures are provided in the parenthesis in the Table 2 below when they contain the preferred entity shown in the Table 1. For example, when the compound (1) of the FIG. 1 has R1 as being a methylene group then its name is given in the parenthesis as 3-methyl-7-oxabicycloheptane. The preferred structure for conducting the reaction involving compound (1) in the FIG. 1 is therefore 3-methyl-7-oxabicycloheptane. All FIGS. 1-19A are to be viewed in this manner for preferred substituents (as shown Table 1) and preferred molecules shown in parenthesis in the Table 2 below.

TABLE 2

| FIG. | Compound | Chemical Name (preferred molecule) |
|---|---|---|
| 1 | 1 | R₁-Cyclohexyl Epoxide (3-methyl-7-oxabicycloheptane) |
| | 2 | R₁-Cyclohexyl Anhydride (5-methylhexahydrobenzo[d][1,3]dioxol-2-one) |
| | 3 | R₁-Dicyclohexyl epoxide (di(7-oxabicycloheptan-3-yl)methane) |
| | 4 | R₁-Dicyclohexyl Dianhydride (5,5′- |
| | | methylenebis(hexahydrobenzo[d][1,3]dioxol-2-one)) |
| | 5 | R₁-Epoxide (2-methyloxirane) |
| | 6 | R₁-Anhydride (4-methyl-1,3-dioxolan-2-one) |
| | 7 | R₁-Diepoxide (di(oxiran-2-yl)methane) |
| | 8 | R₁-Dianhydride (4,4′-methylenebis(1,3-dioxolan-2-one)) |
| 2 | 2 | R₁-Cyclohexyl Anhydride (5-methylhexahydrobenzo[d][1,3]dioxol-2-one) |
| | 9 | Amino, 1,3,-trimethyl(cyclohexyl) methylene urethane (2-hydroxy-4- |
| | | methylcyclohexyl (3-(aminomethyl)-3,5,5-trimethylcyclohexyl)carbamate) |
| | 4 | R₁-Dianhydride (5,5′-methylenebis(hexahydrobenzo[d][1,3]dioxol-2-one)) |
| | 10 | Diamino urethane (methylenebis(6-hydroxycyclohexane-3,1-diyl) bis((3- |
| | | (aminomethyl)-3,5,5-trimethylcyclohexyl)carbamate)) |
| | 6 | R₁-Anhydride (4-methyl-1,3-dioxolan-2-one) |
| | 11a | Isomers of Amino urethane alcohols (3-hydroxy-2-methylpropyl (3- |
| | | (aminomethyl)-3,5,5-trimethylcyclohexyl)carbamate) |
| | 11b | Isomers of Amino urethane alcohols (2-hydroxypropyl (3-(aminomethyl)- |
| | | 3,5,5-trimethylcyclohexyl)carbamate) |
| | 8 | R₁-Dianhydride (4,4′-methylenebis(1,3-dioxolan-2-one)) |
| | 12a | Diamino urethane isomer (2,4-dihydroxypentane-1,5-diyl bis((3- |
| | | (aminomethyl)-3,5,5-trimethylcyclohexyl)carbamate)) |
| | 12b | Diamino urethane isomer (2,4-bis(hydroxymethyl)pentane-1,5-diyl bis((3- |
| | | (aminomethyl)-3,5,5-trimethylcyclohexyl)carbamate)) |
| | 12c | Diamino urethane isomer (2-hydroxy-4-(hydroxymethyl)pentane-1,5-diyl |
| | | bis((3-(aminomethyl)-3,5,5-trimethylcyclohexyl)carbamate)) |
| 3 | 9 | Amino, 1,3,-trimethyl(cyclohexyl) methylene urethane ((2-hydroxy-4- |
| | | methylcyclohexyl (3-(aminomethyl)-3,5,5- |
| | | trimethylcyclohexyl)carbamate)) |
| | 13 | Diamino urethane cyclamate cyclohexyl alcohol (2-hydroxy-4- |
| | | methylcyclohexyl (3,3,5-trimethyl-5-((((4-methylene-1,3-dioxolan-2- |
| | | yl)methyl)amino)methyl)cyclohexyl)carbamate) |
| | 10 | Diamino urethane (methylenebis(6-hydroxycyclohexane-3,1-diyl) bis((3- |
| | | (aminomethyl)-3,5,5-trimethylcyclohexyl)carbamate)) |
| | 14 | methylenebis(6-hydroxycyclohexane-3,1-diyl) bis((3,3,5-trimethy1-5-((((4- |
| | | methylene-1,3-dioxolan-2-yl)methyl)amino)methyl)cyclohexyl)carbamate) |
| | 11a | Isomers of Amino urethane alcohols (3-hydroxy-2-methylpropyl (3- |
| | | (aminomethyl)-3,5,5-trimethylcyclohexyl)carbamate) |
| | 15a | 3-hydroxy-2-methylpropyl (3,3,5-trimethyl-5-((((4-methylene-1,3- |
| | | dioxolan-2-yl)methyl)amino)methyl)cyclohexyl)carbamate |
| | 11b | Isomers of Amino urethane alcohols (2-hydroxypropyl (3-(aminomethyl)- |
| | | 3,5,5-trimethylcyclohexyl)carbamate) |
| | 15b | 2-hydroxypropyl (3,3,5-trimethyl-5-((((4-methylene-1,3-dioxolan-2- |
| | | yl)methyl)amino)methyl)cyclohexyl)carbamate |
| | 12a | Diamino urethane isomer (2,4-dihydroxypentane-1,5-diyl bis((3- |
| | | (aminomethyl)-3,5,5-trimethylcyclohexyl)carbamate)) |
| | 16a | 2,4-dihydroxypentane-1,5-diyl bis((3,3,5-trimethyl-5-((((4-methylene-1,3- |
| | | dioxolan-2-yl)methyl)amino)methyl)cyclohexyl)carbamate) |
| | 12b | Diamino urethane isomer (2,4-bis(hydroxymethyl)pentane-1,5-diyl bis((3- |
| | | (aminomethyl)-3,5,5-trimethylcyclohexyl)carbamate)) |
| | 16b | 2,4-bis(hydroxymethyl)pentane-1,5-diyl bis((3,3,5-trimethyl-5-((((4- |
| | | methylene-1,3-dioxolan-2-yl)methyl)amino)methyl)cyclohexyl)carbamate) |
| | 12c | Diamino urethane isomer (2-hydroxy-4-(hydroxymethyl)pentane-1,5-diyl |
| | | bis((3-(aminomethyl)-3,5,5-trimethylcyclohexyl)carbamate)) |
| | 16c | 2-hydroxy-4-(hydroxymethyl)pentane-1,5-diyl bis((3,3,5-trimethyl-5- |
| | | ((((4-methylene-1,3-dioxolan-2- |
| | | yl)methyl)amino)methyl)cyclohexyl)carbamate) |
| 4 | 9 | Amino, 1,3,-trimethyl(cyclohexyl) methylene urethane ((2-hydroxy-4- |
| | | methylcyclohexyl (3-(aminomethyl)-3,5,5- |
| | | trimethylcyclohexyl)carbamate)) |
| | 17 | 2-hydroxy-4-methylcyclohexyl ((5-((methacryloyloxy)amino)-1,3,3- |
| | | trimethylcyclohexyl)methyl)carbamate |
| | 10 | Diamino urethane (methylenebis(6-hydroxycyclohexane-3,1-diyl) bis((3- |
| | | (aminomethyl)-3,5,5-trimethylcyclohexyl)carbamate)) |
| | 18 | methylenebis(6-hydroxycyclohexane-3,1-diyl) bis(((5- |
| | | ((methacryloyloxy)amino)-1,3,3-trimethylcyclohexyl)methyl)carbamate) |
| | 11a | Isomers of Amino urethane alcohols (3-hydroxy-2-methylpropyl (3- |
| | | (aminomethyl)-3,5,5-trimethylcyclohexyl)carbamate) |
| | 19a | 3-hydroxy-2-methylpropyl (2-(5-((methacryloyloxy)amino)-1,3,3- |
| | | trimethylcyclohexyl)ethyl)carbamate |
| | 11b | Isomers of Amino urethane alcohols (2-hydroxypropyl (3-(aminomethyl)- |
| | | 3,5,5-trimethylcyclohexyl)carbamate) |
| | 19b | 2-hydroxypropyl (3-(((methacryloyloxy)amino)methyl)-3,5,5- |
| | | trimethylcyclohexyl)carbamate |
| | 12a | Diamino urethane isomer (2,4-dihydroxypentane-1,5-diyl bis((3- |
| | | (aminomethyl)-3,5,5-trimethylcyclohexyl)carbamate)) |
| | 20a | 2,4-dihydroxypentane-1,5-diyl bis(((1,3,3-trimethyl-5((3-methyl-2- |
| | | methylenebut-3-en-1-yl)amino)cyclohexyl)methyl)carbamate) |
| | 12b | Diamino urethane isomer (2,4-bis(hydroxymethyl)pentane-1,5-diyl bis((3- |
| | | (aminomethyl)-3,5,5-trimethylcyclohexyl)carbamate)) |
| | 20b | 2,4-bis(hydroxymethyl)pentane-1,5-diyl bis(((1,3,3-trimethyl-5((3- |
| | | methyl-2-methylenebut-3-en-1-yl)amino)cyclohexyl)methyl)carbamate) |
| | 12c | Diamino urethane isomer (2-hydroxy-4-(hydroxymethyl)pentane-1,5-diyl |
| | | bis((3-(aminomethyl)-3,5,5-trimethylcyclohexyl)carbamate)) |
| | 20c | 2-hydroxy-4-(hydroxymethyl)pentane-1,5-diyl bis(((1,3,3-trimethyl-5((3- |
| | | methyl-2-methylenebut-3-en-1-yl)amino)cyclohexyl)methyl)carbamate) |
| 5 | 18 | methylenebis(6-hydroxycyclohexane-3,1-diyl) bis(((5- |
| | | ((methacryloyloxy)amino)-1,3,3-trimethylcyclohexyl)methyl)carbamate) |
| | 21 | methylenebis(6-((4-methylene-1,3-dioxolan-2-yl)methoxy)cyclohexane- |
| | | 3,1-diyl) bis(((5-((methacryloyloxy)amino)-1,3,3- |
| | | trimethylcyclohexyl)methyl)carbamate) |
| 6 | 13 | Diamino urethane cyclamate cyclohexyl alcohol (2-hydroxy-4- |
| | | methylcyclohexyl (3,3,5-trimethyl-5-((((4-methylene-1,3-dioxolan-2- |
| | | yl)methyl)amino)methyl)cyclohexyl)carbamate) |
| | 22 | 2-(4-(diethoxyphosphoryl)butoxy)-4-methylcyclohexyl ((1,3,3-trimethyl- |
| | | 5-(((4-methylene-1,3-dioxolan-2- |
| | | yl)methyl)amino)cyclohexyl)methyl)carbamate |
| | 23 | (4-((2-((((3,3-dimethyl-5-(((4-methylene-1,3-dioxolan-2- |
| | | yl)methyl)amino)cyclohexyl)methyl)carbamoyl)oxy)-5- |
| | | methylcyclohexyl)oxy)butyl)phosphonic acid |
| 6A | 24 | (4-((1-((3-((3-((((5-(N-(3-(3-(acryloyloxy)-2-((2,2,3,3,4,4,4- |
| | | heptafluorobutanoyl)oxy)propoxy)-3-oxopropyl)-2,2,3,3,4,4,4- |
| | | heptafluorobutanamido)-1,3,3- |
| | | trimethylcyclohexyl)methyl)carbamoyl)oxy)-2-(4- |
| | | phosphonobutoxy)propoxy)methyl)cyclohexyl) methoxy)-3-((((5-(N-(3-(3- |
| | | (acryloyloxy)-2-(4-phosphonobutoxy)propoxy)-3-oxopropyl)-2,2,3,3,4,4,4- |
| | | heptafluorobutanamido)-1,3,3- |
| | | trimethylcyclohexyl)methyl)carbamoyl)oxy)propan-2- |
| | | yl)oxy)butyl)phosphonic acid |
| 6B | 25 | (4-(2-((((5-(2,2,3,3,4,4,4-heptafluoro-N-((4-methylene-1,3-dioxolan-2- |
| | | yl)methyl)butanamido)-1,3,3- |
| | | trimethylcyclohexyl)methyl)carbamoyl)oxy)-3-((3((3-((((5-(2,2,3,3,4,4,4- |
| | | heptafluoro-N-((4-methylene-1,3-dioxolan-2-yl)methyl)butanamido)- |
| | | 1,3,3-trimethylcyclohexyl)methyl)carbamoyl)oxy)-2-(4- |
| | | phosphonobutoxy)propoxy)methyl)cyclohexyl)methoxy)propoxy)butyl)ph |
| | | osphonic acid |
| 7 | 13 | Diamino urethane cyclamate cyclohexyl alcohol (2-hydroxy-4- |
| | | methylcyclohexyl (3,3,5-trimethyl-5-((((4-methylene-1,3-dioxolan-2- |
| | | yl)methyl)amino)methyl)cyclohexyl)carbamate) |
| | 26 | 2-(4-(hydroxydimethylene-16-sulfanyl)butoxy)-4-methylcyclohexyl ((1,3,3- |
| | | trimethy1-5-(((4-methylene-1,3-dioxolan-2- |
| | | yl)methyl)amino)cyclohexyl)methyl)carbamate |
| | 27 | 5-methyl-2-((((1,3,3-trimethyl-5-(((4-methylene-1,3-dioxolan-2- |
| | | yl)methyl)amino)cyclohexyl)methyl)carbamoyl)oxy)cyclohexyl 2-(2,5- |
| | | dioxotetrahydrofuran-3-yl)acetate |
| 7A | 28 | 4-((1-((3-((3-((((5-(N-(3-(3-(acryloyloxy)-2-((2,2,3,3,4,4,4- |
| | | heptafluorobutanoyl)oxy)propoxy)-3-oxopropy1)-2,2,3,3,4,4,4- |
| | | heptafluorobutanamido)-1,3,3- |
| | | trimethylcyclohexyl)methyl)carbamoyl)oxy)-2-(4- |
| | | sulfobutoxy)propoxy)methyl)cyclohexyl)methoxy)-3-((((5-(N-(3-(3- |
| | | (acryloyloxy)-2-(4-sulfobutoxy)propoxy)-3-oxopropyl)-2,2,3,3,4,4,4- |
| | | heptafluorobutanamido)-1,3,3- |
| | | trimethylcyclohexyl)methyl)carbamoyl)oxy)propan-2-yl)oxy)butane-1- |
| | | sulfonic acid |
| 7B | 29 | 4-((1-((((5-(2,2,3,3,4,4,4-heptafluoro-N-((4-methylene-1,3-dioxolan-2- |
| | | yl)methyl)butanamido)-1,3,3- |
| | | trimethylcyclohexyl)methyl)carbamoyl)oxy)-3-((3-((2-((((5-(2,2,3,3,4,4,4- |
| | | heptafluoro-N-((4-methylene-1,3-dioxolan-2-yl)methyl)butanamido)- |
| | | 1,3,3-trimethylcyclohexyl)methyl)carbamoyl)oxy)-3-(4- |
| | | sulfobutoxy)propoxy)methyl)cyclohexyl)methoxy)propan-2- |
| | | yl)oxy)butane-1-sulfonic acid |
| 7C | 30 | 3-((3-((2-(2-(2,5-dioxotetrahydrofuran-3-yl)acetoxy)-3-((((5-(N-(3-(2-(2- |
| | | (2,5-dioxotetrahydrofuran-3-yl)acetoxy)-3-(methacryloyloxy)propoxy)-3- |
| | | oxopropyl)-2,2,3,3,4,4,4-heptafluorobutanamido)-1,3,3- |
| | | trimethylcyclohexyl)methyl)carbamoyl)oxy)propoxy)methyl)cyclohexyl)m |
| | | ethoxy)-2-((((5-(N-(3-(2-(2-(2,5-dioxotetrahydrofuran-3-yl)acetoxy)-3- |
| | | (methacryloyloxy)propoxy)-3-oxopropyl)-2,2,3,3,4,4,4- |
| | | heptafluorobutanamido)-1,3,3- |
| | | trimethylcyclohexyl)methyl)carbamoyl)oxy)propyl 2,2,3,3,4,4,4- |
| | | heptafluorobutanoate |
| 7D | 31 | 1-((3-((3-(2-(2,5-dioxotetrahydrofuran-3-yl)acetoxy)-2-((((5- |
| | | (2,2,3,3,4,4,4-heptafluoro-N-((4-methylene-1,3-dioxolan-2- |
| | | yl)methyl)butanamido)-1,3,3- |
| | | trimethylcyclohexyl)methyl)carbamoyl)oxy)propoxy)methyl)cyclohexyl)m |
| | | ethoxy)-3-(((((5S)-5-(2,2,3,3,4,4,4-heptafluoro-N-((4-methylene-1,3- |
| | | dioxolan-2-yl)methyl)butanamido)-1,3,3- |
| | | trimethylcyclohexyl)methyl)carbamoyl)oxy)propan-2-yl 2-(2,5- |
| | | dioxotetrahydrofuran-3-yl)acetate |
| 8 | 32 | 4,4′-(((cyclohexane-1,3- |
| | | diylbis(methylene))bis(oxy))bis(methylene))bis(1,3-dioxolan-2-one) |
| | 33 | 1-((3-((3-((((5-amino-1,3,3-trimethylcyclohexyl)methyl)carbamoyl)oxy)- |
| | | 2-hydroxypropoxy)methyl)cyclohexyl)methoxy)-3-hydroxypropan-2-yl |
| | | ((1,3,3,5-tetramethylcyclohexyl)methyl)carbamate |
| 9 | 33 | 1-((3-((3-((((5-amino-1,3,3-trimethylcyclohexyl)methyl)carbamoyl)oxy)- |
| | | 2-hydroxypropoxy)methyl)cyclohexyl)methoxy)-3-hydroxypropan-2-yl |
| | | ((1,3,3,5-tetramethylcyclohexyl)methyl)carbamate |
| | 34 | 2-hydroxy-3-((3-((3-(((((1-hydroxy-3-((3-((2-hydroxy-3-((((5-((3-(2- |
| | | hydroxy-3-(methacryloyloxy)propoxy)-3-oxopropyl)amino)-1,3,3- |
| | | trimethylcyclohexyl)methyl)carbamoyl)oxy)propoxy)methyl)cyclohexyl)m |
| | | ethoxy)propan-2-yl)oxy)carbonyl)amino)methyl)-3,5,5- |
| | | trimethylcyclohexyl)amino)propanoyl)oxy)propyl methacrylate |
| 10 | 35 | 2-hydroxyethyl methacrylate |
| | 36 | 2,2,3,4,4,4-hexafluorobutyl methacrylate |
| | 37 | ((3,3′-(((21-hydroxy-5-(hydroxymethyl)-11,11,13,13,15,15-hexamethyl- |
| | | 3,24-dioxo-4,7,12,14,19,23-hexaoxa-2,25-diaza-11,13,15- |
| | | trisilahexacosane-1,26-diyl)bis(5,5-dimethylcyclohexane-3,1- |
| | | diyl))bis(azanediyl))bis(propanoyl))bis(oxy))bis(2-hydroxypropane-3,1- |
| | | diyl) bis(2-methylacrylate) |
| | 38 | NIU-DMA hydrogel |
| 11 | 34 | 2-hydroxy-3-((3-((3-(((((1-hydroxy-3-((3-((2-hydroxy-3-((((5-((3-(2- |
| | | hydroxy-3-(methacryloyloxy)propoxy)-3-oxopropyl)amino)-1,3,3- |
| | | trimethylcyclohexyl)methyl)carbamoyl)oxy)propoxy)methyl)cyclohexyl)m |
| | | ethoxy)propan-2-yl)oxy)carbonyl)amino)methyl)-3,5,5- |
| | | trimethylcyclohexyl)amino)propanoyl)oxy)propyl methacrylate |
| | 39 | A name could not be generated for this structure. |
| 12 | 40 | 1-((3-((3-((2,2,3,3,4,4,4-heptafluorobutanoyl)oxy)-2-((((1,3,3-trimethyl-5- |
| | | (((4-methylene-1,3-dioxolan-2- |
| | | yl)methyl)amino)cyclohexyl)methyl)carbamoyl)oxy)propoxy)methyl)cyclo |
| | | hexyl)methoxy)-3-((((1,3,3-trimethyl-5-(((4-methylene-1,3-dioxolan-2- |
| | | yl)methyl)amino)cyclohexyl)methyl)carbamoyl)oxy)propan-2-yl |
| | | 2,2,3,3,4,4,4-heptafluorobutanoate |
| 12A | 41 | 1-((((5-(2,2,3,3,4,4,4-heptafluoro-N-((4-methylene-1,3-dioxolan-2- |
| | | yl)methyl)butanamido)-1,3,3- |
| | | trimethylcyclohexyl)methyl)carbamoyl)oxy)-3-((3-((2-((((5-(2,2,3,3,4,4,4- |
| | | heptafluoro-N-((4-methylene-1,3-dioxolan-2-yl)methyl)butanamido)- |
| | | 1,3,3-trimethylcyclohexyl)methyl)carbamoyl)oxy)-3-((2,2,3,3,4,4,4- |
| | | heptafluorobutanoyl)oxy)propoxy)methyl)cyclohexyl)methoxy)propan-2- |
| | | yl 2,2,3,3,4,4,4-heptafluorobutanoate |
| 13 | 42 | (4-((1-(methacryloyloxy)-3-((3-((3-(((((1-((3-((3-((((5-((3-(3- |
| | | (methacryloyloxy)-2-(4-phosphonobutoxy)propoxy)-3-oxopropyl)(4- |
| | | phosphonobutyl)amino)-1,3,3- |
| | | trimethylcyclohexyl)methyl)carbamoyl)oxy)-2-(4- |
| | | phosphonobutoxy)propoxy)methyl)cyclohexyl)methoxy)-3-(4- |
| | | phosphonobutoxy)propan-2-yl)oxy)carbonyl)amino)methyl)-3,5,5- |
| | | trimethylcyclohexyl)(4-phosphonobutyl)amino)propanoyl)oxy)propan-2- |
| | | yl)oxy)butyl)phosphonic acid |
| 14 | 43 | A name could not be generated for this structure. |
| 15 | 44 | A name could not be generated for this structure. |
| 16 | 45 | 2-((perfluorophenyl)methoxy)-3-((3-((3-((perfluorophenyl)methoxy)-2- |
| | | ((((1,3,3-trimethyl-5-(((4-methylene-1,3-dioxolan-2- |
| | | yl)methyl)amino)cyclohexyl)methyl)carbamoyl)oxy)propoxy)methyl)cyclo |
| | | hexyl)methoxy)propyl ((1,3,3-trimethyl-5-(((4-methylene-1,3-dioxolan-2- |
| | | yl)methyl)amino)cyclohexyl)methyl)carbamate |
| 16A | 46 | 2-((perfluorophenyl)methoxy)-3-((3-((3-((perfluorophenyl)methoxy)-2- |
| | | ((((1,3,3-trimethyl-5-(((4-methylene-1,3-dioxolan-2- |
| | | yl)methyl)((perfluorophenyl)methyl)amino)cyclohexyl)methyl)carbamoyl |
| | | )oxy)propoxy)methyl)cyclohexyl)methoxy)propyl ((1,3,3-trimethyl-5-(((4- |
| | | methylene-1,3-dioxolan-2- |
| | | yl)methyl)((perfluorophenyl)methyl)amino)cyclohexyl)methyl)carbamate |
| 17 | 47 | 3-((3-((3-(((((1-((3-((3-((((5-((3-(3-(methacryloyloxy)-2- |
| | | ((perfluorophenyl)methoxy)propoxy)-3- |
| | | oxopropyl)((perfluorophenyl)methyl)amino)-1,3,3- |
| | | trimethylcyclohexyl)methyl)carbamoyl)oxy)-2- |
| | | ((perfluorophenyl)methoxy)propoxy)methyl)cyclohexyl)methoxy)-3- |
| | | ((perfluorophenyl)methoxy)propan-2-yl)oxy)carbonyl)amino)methyl)- |
| | | 3,5,5- |
| | | trimethylcyclohexyl)((perfluorophenyemethyl)amino)propanoyl)oxy)-2- |
| | | ((perfluorophenyl)methoxy)propyl methacrylate |
| 18 | 48 | A name could not be generated for this structure. |
| 19 | 49 | 2-(((3,3,4,4,5,5,6,6,7,7,8,8,9,9,10,10,10- |
| | | heptadecafluorodecyl)dimethylsilyl)oxy)-3-((3-((3- |
| | | (((3,3,4,4,5,5,6,6,7,7,8,8,9,9,10,10,10- |
| | | heptadecafluorodecyl)dimethylsilyl)oxy)-2-((((1,3,3-trimethyl-5-(((4- |
| | | methylene-1,3-dioxolan-2- |
| | | yl)methyl)amino)cyclohexyl)methyl)carbamoyl)oxy)propoxy)methyl)cyclo |
| | | hexyl)methoxy)propyl ((1,3,3-trimethyl-5-(((4-methylene-1,3-dioxolan-2- |
| | | yl)methyl)amino)cyclohexyl)methyl)carbamate |
| 19A | 50 | 3-((3-((2-((((5-(((3,3,4,4,5,5,6,6,7,7,8,8,9,9,10,10,10- |
| | | heptadecafluorodecyl)dimethylsilyl)((4-methylene-1,3-dioxolan-2- |
| | | yl)methyl)amino)-1,3,3-trimethylcyclohexyl)methyl)carbamoyl)oxy)-3- |
| | | (((3,3,4,4,5,5,6,6,7,7,8,8,9,9,10,10,10- |
| | | heptadecafluorodecyl)dimethylsilyl)oxy)propoxy)methyl)cyclohexyl)meth |
| | | oxy)-2-(((3,3,4,4,5,5,6,6,7,7,8,8,9,9,10,10,10- |
| | | heptadecafluorodecyl)dimethylsilyl)oxy)propyl ((5- |
| | | (((3,3,4,4,5,5,6,6,7,7,8,8,9,9,10,10,10- |
| | | heptadecafluorodecyl)dimethylsilyl)((4-methylene-1,3-dioxolan-2- |
| | | yl)methyl)amino)-1,3,3-trimethylcyclohexyl)methyl)carbamate |

In an embodiment, the composition for manufacturing the polyurethane hydrogel can include the acrylamide, the fluorine functionalized acrylate and the non-isocyanate urethane acrylate. In one embodiment, the non-isocyanate urethane acrylate is a non-isocyanate urethane dimethacrylate. In an embodiment, the non-isocyanate urethane acrylates and dimethacrylates of the formulas (XI) to (XIV) (either singly or in combination) above may be used in the composition to manufacture the polyurethane hydrogel.

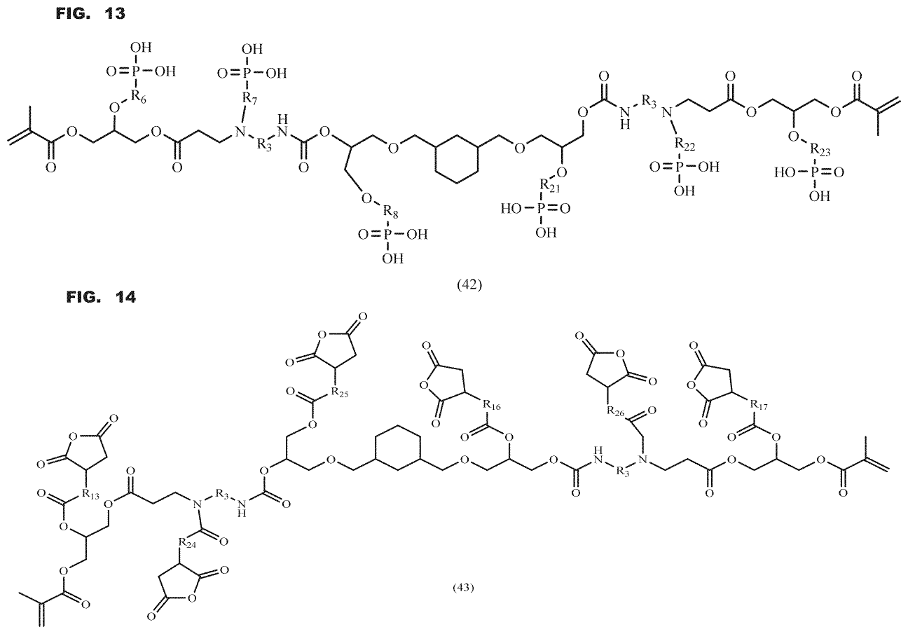

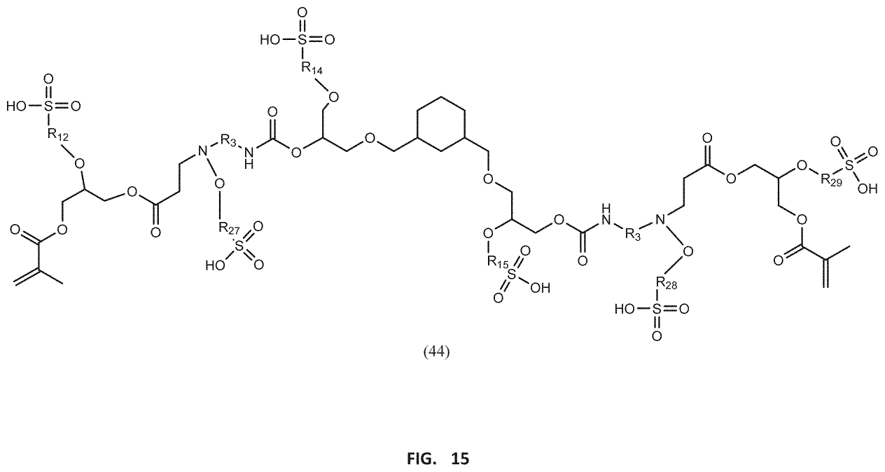

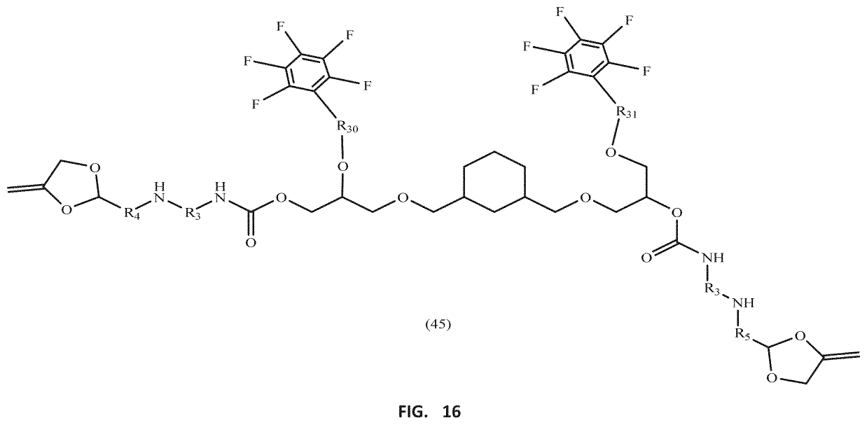

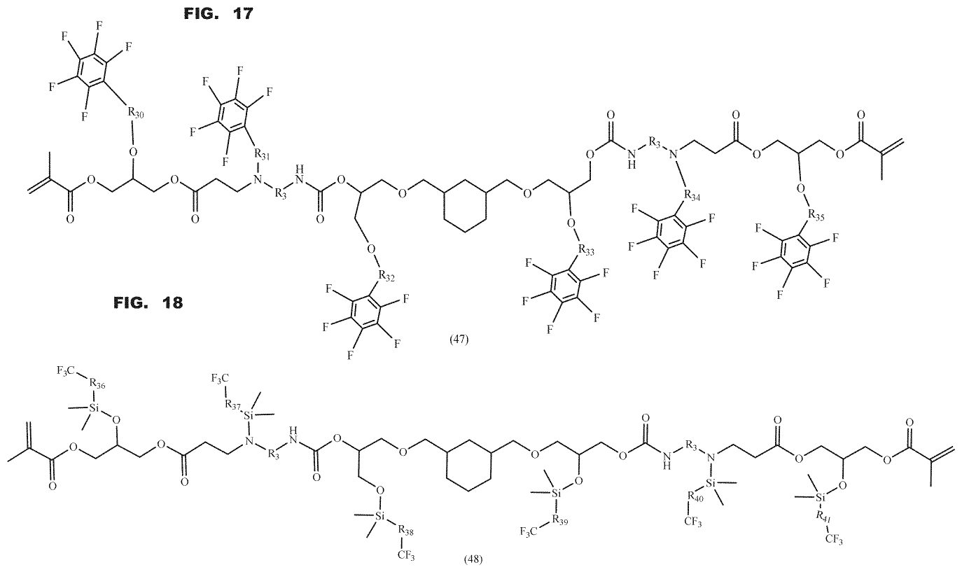

In another embodiment, the non-isocyanate urethane acrylates and dimethacrylates of the FIG. 4 (see structures 18, 19a, 19b, 20a, 20b, 20c, or combinations thereof), FIG. 5 (see structure 21), FIG. 6A (see structure 24), FIG. 7A (see structure 28), FIG. 7C, FIG. 7D (see structure 31), FIG. 9 (see structure 34), FIG. 11 (see structure 39), FIG. 12, FIG. 12A (see structure 41), FIG. 13 (see structure 42), FIG. 14 (see structure 43), FIG. 15 (see structure 44), FIG. 17 (see structure 47), FIG. 18 (see structure 48), or combinations thereof may be combined with the acrylamide and the fluorine functionalized di(meth)acrylate to produce the polyurethane copolymer in its hydrogel form.

The non-isocyanate urethane acrylates and dimethacrylates are added to the composition in an amount of 5 to 20 moles or 10 to 15 moles, based on the total weight of the composition.

The polyurethane copolymers may further include other thermoplastic and/or thermosetting (crosslinked) polyurethanes that are not manufactured via the use of isocyanates or polyisocyanates.

In an embodiment, the thermoplastic and/or thermosetting polyurethanes may be further copolymerized with at least one or more water-soluble monomers or polymers. The water soluble polymers can be synthetic polymers (manufactured from man-made monomers) or naturally occurring polymers and can be added to the composition during the reaction to produce the polyurethane hydrogel.

As noted above, water soluble monomers other than acrylamide may be used. The synthetic water-soluble monomers can include vinyl alcohol, vinyl pyrrolidone, ethylene glycol, polyacrylic acid, N-(2-hydroxypropyl) methacrylamide, divinyl ether-maleic anhydride, oxazoline, phosphazene, or a combination thereof. Polymers derived from the foregoing monomers (prior to the reaction to produce the urethane hydrogels) may also be used.

The naturally occurring water soluble polymers include xanthan gum, pectin (which comprises a mixture of polysaccharides), carrageenan, guar gum, cellulose ethers (e.g., hydroxypropylmethyl cellulose (HPMC), hydroxypropyl cellulose (HPC), hydroxyethyl cellulose (HEC), sodium carboxy methyl cellulose (Na-CMC), or a combination thereof), hyaluronic acid (HA), albumin, starch or starch based derivatives, or a combination thereof.

The water soluble polymers that are used in or copolymerized with the polyurethanes may be in monomeric form or polymeric form prior to the copolymerization. In an embodiment, the water soluble polymers are added in monomeric form to the reactants that produce the polyurethanes. The reaction between the water soluble monomers and the reactants that produce the polyurethanes result in the formation of the copolymers.

The water soluble polymer may be present in an amount of 5 to 95 wt %, preferably 15 to 80 wt %, and more preferably 20 to 70 wt %, based on the total weight of the copolymer.

In another embodiment, non-water soluble polymers may be copolymerized with the polyurethane to form the copolymer. In yet another embodiment, the non-water soluble polymer may be present in the copolymer in addition to the water soluble polymer. The non-water soluble polymer may be produced by adding a monomer (that produces the non-water soluble polymer) to a reaction mixture that contains the reactants (that produce the polyurethane and the monomers that produce the water soluble polymer).

The non-water soluble polymer may be present in an amount of 5 to 95 wt %, preferably 15 to 80 wt %, and more preferably 20 to 70 wt %, based on the total weight of the copolymer.

The non-isocyanate polyurethane may be covalently or ionically bonded to the water soluble polymer and/or the non-water soluble polymer. The resulting copolymer may be thermoplastic or a thermoset (i.e., a crosslinked polymer). In an embodiment, the resulting copolymer may function as a hydrogel.

The resulting copolymer has a strain at break that is greater than 100%, preferably greater than 105%. The resulting copolymer has a toughness greater than 2 MPa, preferably greater than 4 MPa, and more preferably greater than 6 MPa.

In an embodiment, in one manner of manufacturing the composition, the acrylamide, the fluorine functionalized acrylate and the non-isocyanate urethane di(meth)acrylate may be mixed together with or without solvents and reacted to form the urethane copolymer. A suitable initiator may be to the composition if desired. A useful initiator is a benzyl dimethyl ketal (Irgacure 651).

The composition may be reacted using thermal energy or radiation. In an embodiment, the radiation is UV radiation. The composition may be shaped during the curing process using a mold or a stamp.

The composition and the resulting polyurethane hydrogels are exemplified by the following non-limiting examples.

### EXAMPLES

### Materials

The materials used in the examples are (E9)2,3-epoxypropoxypropyl-poly dimethylsiloxane, PDMS (epoxy eq/kg=5.5, MW=363 g/mol), (E11)2,3-epoxypropoxypropyl-polydimethylsiloxane, PDMS (epoxy eq/kg=2.05, MW=500-600 g/mol), (E12)2,3-epoxypropoxypropyl-polydimethylsiloxane, PDMS (epoxy eq/kg=1.6-1.9, MW=1000-1400 g/mol) obtained from Gelest. Tetrabutylammonium bromide (TBAB), 5-amino-1,3,3-trimethylcyclohexanemethyl-amine (>99%, 0.922 g/mL at 25° C.), 3-(Acryloyloxy)-2-hydroxypropyl methacrylate (AHM) were obtained from Sigma-Aldrich. Sodium sulfate, Na₂SO₄ (anhydrous), sodium bicarbonate and methylene chloride (CH₂Cl₂) were obtained from Fisher Scientific. Ethyl acetate (HPLC grade) was obtained from ACROS organics and Deionized (DI) water (>17.8 MΩ-cm resistivity) was obtained from the Thermo Scientific Branstead EASY pure II system. Nitrogen gas (N₂, ultra-high purity) and carbon dioxide (CO₂) were provided by Airgas. Acrylamide electrophoresis grade (Sigma A3553), 2,2,3,4,4,4-hexafluorobutyl methacrylate (Sigma 37197), 2,2-dimethoxy-2 phenylacetophenone (Sigma 196118) Irgacure 651 and 100% Ethanol (Fisher Scientific, CAS no. 64174) were also used in the examples below.

### Example 1

### Synthesis of Non-Isocyanate Urethane Dimethacrylate:

The oxirane groups of 2, 3-epoxypropoxy propyl-polydimethylsiloxane were converted to cyclic carbonate groups by a reaction with carbon dioxide. The cyclic carbonate compound reacts with 5 amino-1,3,3-trimethyl(cyclohexane methylamine) to form a hydroxyurethane. The functional primary amine was then reacted with 3-(acryloyloxy)-2-hydroxypropyl methacrylate in order to obtain methacrylate terminal groups.

Synthesis of Cyclic Carbonate Terminated PDMS:

2, 3-epoxypropoxy-PDMS (EP-PDMS) (30.0 g) (E9,E11,E12) was mixed with 5 mol % TBAB in a 100 mL 3-neck flask. The reaction was heated to 70° C. until catalyst completely dissolved. The CO₂ gas was turned on and reaction was kept at 120° C. for 24 h. Ethyl acetate and water were used to remove excess catalyst. Before removal of solvent, excess water was removed with Na₂SO₄. The TBAB was removed using activated charcoal and vacuum distillation.

Synthesis of Amine Terminated PDMS:

Amine-terminated non-isocyanate urethane PDMS (AT-NIU) was synthesized according to the method as follows. A solution of 5-amino-1, 3, 3-trimethyl(cyclohexane methylamine) (2.25 g) and previously synthesized cyclic carbonate compound (3.52 g) was mixed with CH₂Cl₂ (5 ml) under N₂ gas. The reaction took 24 h at room temperature. Unreacted amines were removed by extracting with brine and DI water. Before solvent evaporation, the product was mixed with anhydrous Na₂SO₄ to remove excess water and filtered.

Synthesis of Methacrylate Terminated Non-Isocyanate Urethane:

Methacrylate terminated NIU-DMA was synthesized via Michael addition.

AHM (7.33 g) was added drop-wise to previously synthesized amine terminated NIU (25 g) at 5° C. in CH₂Cl₂ under N₂ gas. After all the material was mixed thoroughly, the reaction mixture was stirred at room temperature for 6 days. The solvent was evaporated at <30° C. using vacuum distillation.

Method for Synthesis of Hydrogel:

The following optimization table (Table 1) was generated using a 3 level factorial response of a Taguchi design using the Minitab software. The parameters of exposure time, moles of (non-isocyanate urethane dimethacrylate) NIUDMA, moles of (acrylamide) AAm and moles of (hydroxyfluorobutyl dimethacrylate) HFBMA were constrained to 3 levels. Three samples of microscope slide size (75 mm by 25 mm) of each reaction number were prepared. Pre-polymerization solutions were prepared by adding acrylamide, HFBMA, and NIU-DMA (E-9)/NIU-DMA (E-11)/NIU-DMA (E-12) to borosilicate glass scintillation vials at varying ratios for each respective composition. The monomers were mixed with 40 wt % ethanol at 50° C. until the solution was mixed thoroughly. After the solution had cooled to room temperature, Irgacure 651 (0.5 wt %) was added and the solutions were mixed until the photo-initiator dissolved completely. Pre-polymerization solutions were purged with N₂ for 2 min to eliminate dissolved O₂. The pre-polymerization solutions were then transferred by pipette into molds consisting of a fluoroelastomer (Viton®) gasket (thickness of 0.8 mm) sandwiched between two glass plates and polymerized by UV irradiation using a Lesco CureMax FEM1011 UV curing system equipped with a 300 W, 230 V Osram ULTRA VITALUX bulb (UVA, UVB radiation 280-400 nm, 785.6 mW/cm²). Gel-coated glass slides were fabricated by treating glass slides with MPS solution, and including the glass slide in the molds. Gels were removed from the molds, and unreacted components were removed by immersion in 50% v/v ethanol/DI water for one day. The gels were then immersed in 25% v/v ethanol/DI water for an additional 24 h followed by equilibration in DI water.

Table 1 depicts the compositions used for manufacturing the hydrogels.

TABLE 1

| | | Monomer | | |
|---|---|---|---|---|
| Reaction | | moles used | | Reaction |
| number | AAm | HFBMA | NIUDMA | time (min) |
| 1 | 20 | 20 | 5 | 4 |
| 2 | 20 | 45 | 10 | 6 |
| 3 | 20 | 70 | 20 | 8 |
| 4 | 45 | 20 | 10 | 8 |
| 5 | 45 | 45 | 20 | 4 |
| 6 | 45 | 70 | 5 | 6 |
| 7 | 70 | 20 | 20 | 6 |
| 8 | 70 | 45 | 5 | 8 |
| 9 | 70 | 70 | 10 | 4 |

### Mechanical Tests

Elastic modulus of the gels was examined by implementation of ASTM D638 using the TA.XT.Plus® Texture Analyzer equipped with a 2 kg load cell. Tests were conducted at room temperature. Water equilibrated dog-bone shaped samples with a gauge length of 16 mm were tested at 2 mm/sec until sample failure. The elastic modulus was calculated by determining the slope of the stress-strain curve at the elastic region. The integrated area under the stress-strain curve before fracture was calculated with the Exponent software to determine the toughness.

Table 2 below shows one particular formulation along with measured properties.

TABLE 2

| | NIUDMA (E-9) | NIUDMA (E-11) | NIUDMA (E12) |
|---|---|---|---|
| AAm | 70 | 70 | 45 |
| HFBMA | 45 | 45 | 70 |
| NIUDMA | 5 | 5 | 5 |
| Curing time | 8 mins | 8 mins | 6 mins |
| Toughness (MPa) | 7.15 ± 1.81 | 2.59 ± 0.78 | 3.56 ± 0.69 |
| Modulus (MPa) | 37.7 ± 7.5 | 55.6 ± 3 | 71.6 ± 9.94 |
| Strain at Break (%) | 160 ± 25 | 109 ± 17 | 131 ± 4 |
| Contact | L:70.3 ± 1.34 | L:65.4 ± 1.05 | L:67.6 ± 1.88 |
| Angle | R:70.4 ± 1.84 | R:66.4 ± 1.24 | R:67.1 ± 0.91 |

From the Table 2, it may be seen that the maximum toughness for the short length crosslinker E9 (MW=363 g/mol) is 7.15±1.81 MPa compared to longer length crosslinker E12 (MW=1.2-1.4 kg/mol) which is 3.56±0.69 MPa. On the other hand, the modulus for was short length crosslinker E9 is 37.7±7.5 MPa compared to 71.6±9.9 MPa for E12.

### Equilibrium Water Uptake

Fully dehydrated hydrogels of the different formulations were punched out in disks of diameter 3 mm and weighed using a weighing balance. They were immersed fully in Falcon Polystyrene petri dishes (60 mm×15 mm) containing deionized water. Weights of the disks were taken till 24 hours until the reading appeared constant. The percentage equilibrium water content was then calculated and plotted as a function of time. Table 3 shows the equilibrium water uptake (EWC) for the different samples.

TABLE 3

| | NIUDMA | NIUDMA | NIUDMA |
|---|---|---|---|
| | (E-9) | (E-11) | (E-12) |
| EWC (%) | 45.3 | 24.1 | 4.54 |

From the tables above, it may be seen that the polyurethane hydrogels manufactured herein have a toughness of 2.5 to 8 MPa, preferably 2.6 to 7.75 MPa when measured as described above (as per ASTM D638) at room temperature. It may also be seen that the samples have an elastic modulus of 20 to 75 MPa, preferably 25 to 70 MPa when measured as per ASTM D638.

The hydrogels also show an equilibrium water uptake of 3 to 50 weight percent of water, preferably 4 to 46 weight percent, based on a total weight of the hydrogel prior to equilibration.

It is to be noted that all ranges detailed herein include the endpoints. Numerical values from different ranges are combinable.

The transition term “comprising” encompasses the transition terms “consisting of” and “consisting essentially of”.

The term “and/or” includes both “and” as well as “or”. For example, “A and/or B” is interpreted to be A, B, or A and B.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. A composition comprising:
a water soluble monomer or polymer;
a fluorine functionalized acrylate; and
a non-isocyanate urethane acrylate.

2. The composition of claim 1, where the water soluble monomer comprises an acrylamide.

3. The composition of claim 1, where the water soluble monomer comprises vinyl alcohol, vinyl pyrrolidone, ethylene glycol, polyacrylic acid, N-(2-hydroxypropyl) methacrylamide, divinyl ether-maleic anhydride, oxazoline, phosphazene, or a combination thereof.

4. The composition of claim 1, where the water soluble monomer comprises xanthan gum, pectin, carrageenan, guar gum, cellulose ethers, sodium carboxy methyl cellulose, hyaluronic acid (HA), albumin, starch or starch based derivatives, or a combination thereof.

5. The composition of claim 1, where the fluorine functionalized acrylate has the structure represented by the formula (1a): 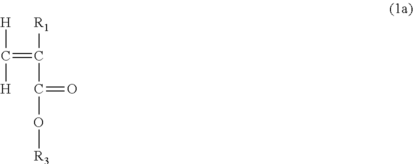
where R₁ is a hydrogen or an alkyl group having 1 to 10 carbon atoms and R₃ is a C₂₋₁₀ fluoroalkyl group or a group having the structure of formula (2a):
—R₄—(CF₂)n-CF₃ (2a),
where R₄ in the formula (2a) is an alkyl group having 1 to 10 carbon atoms and n has a value of 1 to 10.

6. The composition of claim 1, where the fluorine functionalized acrylate is hexafluorobutyl (meth)acrylate.

7. The composition of claim 1, where the non-isocyanate urethane acrylate has the structure of the formulas (XI) to (XIV): 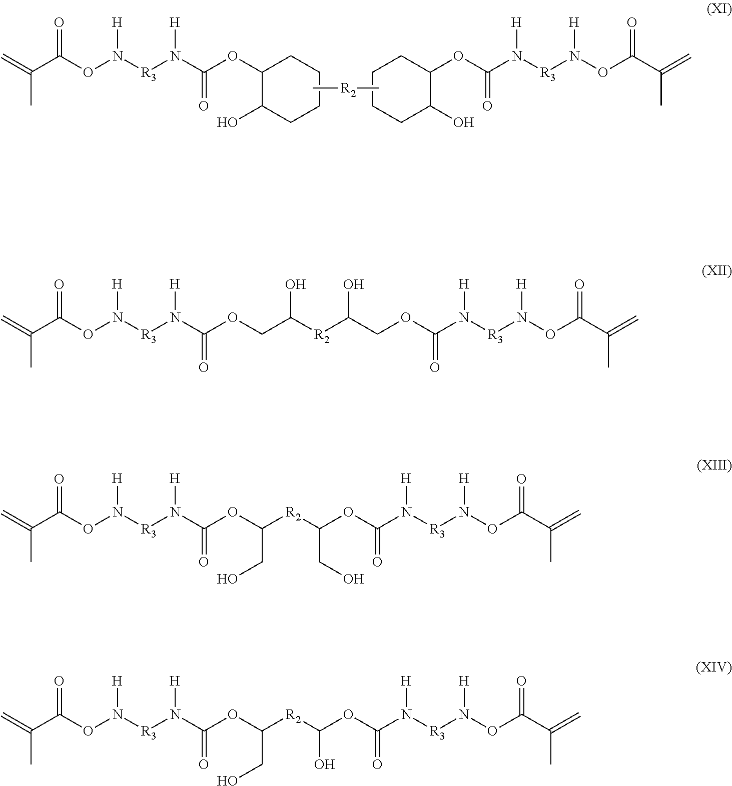
where in the formulas (XI) through (XIV), the bridging moieties R1, R2 and R3 are independently a straight chain or branched C1-30 alkyl, a C3-30 cycloalkyl, a C6-30 aryl, C7-30 alkaryl, a C7-30 aralkyl, a C1-30 heteroalkyl, a C3-30 heterocycloalkyl, a C6-30 heteroaryl, a C7-30 heteroalkaryl, a C7-30 heteroaralkyl, or a combination thereof.

8. The composition of claim 1, where the non-isocyanate urethane acrylate comprises the structure depicted in the FIG. 4 (see structures 18, 19a, 19b, 20a, 20b, 20c, or combinations thereof), FIG. 5 (see structure 21), FIG. 6A (see structure 24), FIG. 7A (see structure 28), FIG. 7C, FIG. 7D (see structure 31), FIG. 9 (see structure 34), FIG. 11 (see structure 39), FIG. 12, FIG. 12A (see structure 41), FIG. 13 (see structure 42), FIG. 14 (see structure 43), FIG. 15 (see structure 44), FIG. 17 (see structure 47), FIG. 18 (see structure 48), or combinations thereof.

9. A polyurethane hydrogel derived from the composition of claim 1.

10. A method comprising:
mixing a water soluble monomer or polymer, a fluorine functionalized acrylate and a non-isocyanate urethane acrylate to form a composition; and
curing the composition.

11. A polyurethane copolymer comprising:
a water soluble polymer; where the water soluble polymer is covalently or ionically bonded to a non-isocyanate containing polyurethane;
where the non-isocyanate containing polyurethane is derived via polymerization of a composition comprising:
a water soluble monomer or polymer;
a fluorine functionalized acrylate; and
a non-isocyanate urethane acrylate.

12. The polyurethane copolymer of claim 11, further comprising a non-water soluble polymer.

13. The polyurethane copolymer of claim 11, where the non-water soluble polymer is covalently or ionically bonded to the non-isocyanate containing polyurethane and/or the water soluble polymer.

14. The polyurethane copolymer of claim 11, where the polyurethane copolymer functions as a hydrogel.

15. A method of manufacturing a polyurethane copolymer comprising:
reacting a non-isocyanate containing polyurethane with a water soluble polymer to produce the polyurethane copolymer, where the water soluble polymer is covalently or ionically bonded to the non-isocyanate containing polyurethane and where the non-isocyanate containing polyurethane is derived via polymerization of a composition comprising:
a water soluble monomer or polymer;
a fluorine functionalized acrylate; and
a non-isocyanate urethane acrylate.

16. The method of manufacturing the polyurethane copolymer of claim 15, further comprising reacting a non-water soluble polymer with the non-isocyanate containing polyurethane and/or the water soluble polymer.
